(19) United States
(12) Patent Application Publication
(10) Pub. No.: US 2025/0080880 A1
(43) Pub. Date: Mar. 6, 2025

(54) PHOTOELECTRIC CONVERSION APPARATUS, MOVABLE APPARATUS, CONTROL METHOD, AND STORAGE MEDIUM

(71) Applicant: CANON KABUSHIKI KAISHA, Tokyo (JP)

(72) Inventor: Yuya KURATA, Tochigi (JP)

(21) Appl. No.: 18/801,889

(22) Filed: Aug. 13, 2024

(30) Foreign Application Priority Data
Aug. 30, 2023 (JP) 2023-139501

(51) Int. Cl. H04N 25/773; H04N 23/61; H04N 25/76; H04N 25/771; H04N 25/79

(52) U.S. Cl. CPC H04N 25/773; H04N 23/61; H04N 25/771; H04N 25/7795; H04N 25/79

(57) ABSTRACT

A photoelectric conversion apparatus comprises an optical system and a plurality of pixels, each pixel provided with a photoelectric conversion unit configured to generate pulses in response to photons, a counter configured to count the number of the pulses, and a memory configured to store a count value of the counter, wherein the apparatus generates a signal based on the difference between the count value of the counter at the start time and end time of an accumulation period in the photoelectric conversion unit, includes at least a first accumulation period and a second accumulation period within one full frame period, the first accumulation period being shorter than the second accumulation period, and controls the signal generated during the first accumulation period to be output during the period from the end of the first accumulation period to the end of the second accumulation period. In addition, the apparatus includes a setting unit configured to set, in a sensor unit including the plurality of pixels, a first pixel region having at least the first accumulation period and the second accumulation period, and a second pixel region having at least the second accumulation period.

### BACKGROUND OF THE INVENTION

### Field of the Invention

The present invention relates to a photoelectric conversion apparatus, a movable apparatus, a control method, a storage medium, and the like.

### Description of the Related Art

In recent years, photoelectric conversion apparatuses have been developed that digitally count the number of photons that are incident on an avalanche photodiode (APD), and output the counted value from a pixel as a photoelectrically converted digital signal.

In addition, for example, in Japanese Patent No. 7223070, a configuration is disclosed in which, in a photoelectric conversion apparatus that includes an APD, it is possible to output a plurality of images with overlapping accumulation periods, and continuous shooting becomes possible even in low light conditions. In addition, in Japanese Patent Laid-Open Publication No. 2021-34786, a configuration is disclosed in which signals are read out at a high frame rate from a pixel region in which a moving subject has been detected.

However, for example, assuming the case of an image sensor of a camera, because recognition processing is performed on a frame-by-frame basis in a standard sensor driving unit, for example, in the case of 30 fps (frames per second), recognition processing can only be executed every 33.3 ms. Therefore, in a standard camera, even if an object emerges immediately after a frame switch, recognition processing cannot be performed until the end of the frame.

In contrast, for example, in a monitoring system that uses an in-vehicle camera, it is necessary for the system to accurately and quickly recognize vehicles or people that suddenly emerge from areas that are blind spots for the driver in order to reduce risks such as collisions.

For this reason, it is required for an in-vehicle camera to acquire and recognize images with high resolution and in a short period of time. However, there are problems in performing image capturing with high resolution and a short frame rate, such as an increase in data volume and an increase in power consumption.

### SUMMARY OF THE INVENTION

A photoelectric conversion apparatus according to one aspect of the present invention comprises:
an optical system;
a plurality of pixels, each provided with:
   a photoelectric conversion unit configured to generate pulses in response to photons;
   a counter configured to count the number of the pulses; and
   a memory configured to store a count value of the counter;
one or more memories storing instructions; and
one or more processors executing the instructions to:
   generate a signal based on the difference between the count value of the counter at the start time and end time of an accumulation period in the photoelectric conversion unit;
   control a signal generated during a first accumulation period so that the signal is output during the period from the end of the first accumulation period to the end of a second accumulation period, wherein the first accumulation period is shorter than the second accumulation period, and wherein in one full-frame period, the first accumulation period and a second accumulation period longer than the first accumulation period are included; and
   set, in a sensor unit including the plurality of pixels, a first pixel region having at least the first accumulation period and the second accumulation period, and a second pixel region having at least the second accumulation period.

Further features of the present invention will become apparent from the following description of embodiments with reference to the attached drawings.

### BRIEF DESCRIPTION OF THE DRAWINGS

FIG. 1 is a diagram showing a configuration example of a sensor unit 100 according to a First Embodiment.

FIG. 2 is a diagram showing a configuration example of a sensor unit substrate 11 according to the First Embodiment.

FIG. 3 is a diagram showing a configuration example of a circuit substrate 21 according to the First Embodiment.

FIG. 4 is a diagram showing the equivalent circuit of a photoelectric conversion unit 102 and a signal processing circuit 103 corresponding to the photoelectric conversion unit 102 among FIG. 2 and FIG. 3.

FIG. 5 is a diagram schematically showing the relationship between the operation of an APD 201 and the output signal.

FIG. 6 is a functional block diagram of a photoelectric conversion apparatus 600 according to the First Embodiment.

FIG. 7 is a diagram for explaining the photoelectric conversion method by a control unit 605 according to the First Embodiment.

FIG. 8 is a diagram showing an example of images of a plurality of divided accumulation periods according to the First Embodiment.

FIG. 9 is a diagram showing the relationship between memories and buffers in the First Embodiment.

FIG. 10 is a flowchart showing details of a driving example of the sensor unit 100 in the First Embodiment.

FIG. 11 is a continuation of the flowchart of FIG. 10.

FIG. 12 is a diagram explaining an example of setting an attention region with respect to a movable apparatus in the First Embodiment.

FIG. 13 is a functional block diagram showing a configuration example of the photoelectric conversion apparatus 600 and a movable apparatus 700 according to a Third Embodiment.

FIG. 14 is a flowchart explaining a control method of a movable apparatus according to the Third Embodiment.

FIG. 15 is a flowchart explaining a control method of the movable apparatus according to a Fourth Embodiment.

FIG. 16 is a flowchart showing details of a driving example of the sensor unit 100 with respect to the method of setting a region of interest according to a Sixth Embodiment.

FIG. 17 is a continuation of the flowchart of FIG. 16.

FIG. 18 is a diagram showing an example of images for each of a plurality of accumulation periods, in which a region of interest is set.

FIG. 19 is a flowchart showing details of an example of driving of the sensor unit 100 by setting the accumulation period in a Seventh Embodiment.

FIG. 20 is a continuation of the flowchart of FIG. 19.

FIG. 21 is a flowchart showing an example of the operation in the control unit after composing an image according to an Eighth Embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

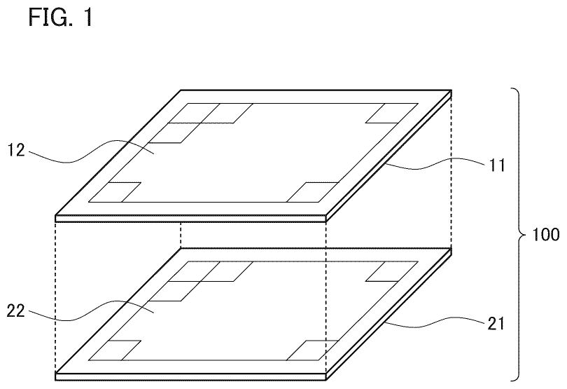

FIG. 1 is a diagram showing a configuration example of a sensor unit 100 according to the First Embodiment. Below, an explanation is given of a sensor unit, which is a so-called stacked structure in which a sensor unit is configured by two boards of a sensor unit substrate 11 and a circuit substrate 21 that are stacked together and electrically connected.

However, the configuration that is included in the sensor unit substrate 11 and the configuration that is included in the circuit substrate may also be so-called non-stacked structures that have been disposed on a shared semiconductor layer. The sensor unit substrate 11 includes a pixel region 12. The circuit substrate 21 includes a circuit region 22 in which a signal that has been detected in the pixel region 12 is processed.

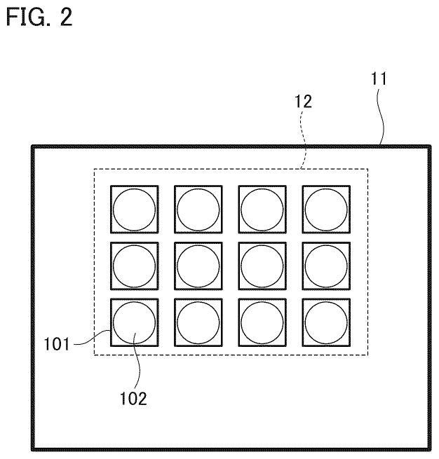

FIG. 2 is a diagram showing a configuration example of the sensor unit substrate 11 according to the First Embodiment. The pixel region 12 of the sensor unit substrate 11 includes a plurality of pixels 101 that have been arranged two-dimensionally across a plurality of row and column directions.

A pixel 101 is provided with a photoelectric conversion unit 102 configured to include an avalanche photodiode (hereinafter, referred to as “APD”). Here, the photoelectric conversion unit 102 generates pulses with a frequency in response to a reception frequency of photons. That is, the photoelectric conversion unit 102 generates a pulse in response to the incidence of a photon. Note that there are no specific limitations for the number of rows and number of columns for the pixel array that configures the pixel region 12.

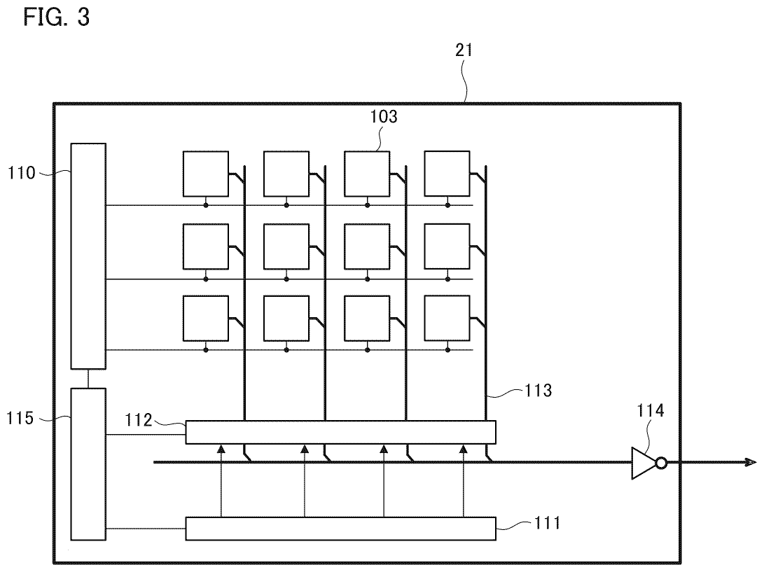

FIG. 3 is a diagram showing a configuration example of the circuit substrate 21. The circuit substrate 21 includes signal processing circuits 103 that process charges photoelectrically converted by each photoelectric conversion unit 102 shown in FIG. 2, a reading circuit 112, a control pulse generation unit 115, a horizontal scanning circuit 111, vertical signal lines 113, a vertical scanning circuit 110, and an output circuit 114.

The vertical scanning circuit 110 receives a control pulse supplied from the control pulse generating unit 115, and supplies the control pulse to a plurality of pixels arranged in the row direction sequentially. The vertical scanning circuit 110 is configured by a logic circuit such as a shift register or an address decoder.

The signals that have been output from the photoelectric conversion unit 102 of each pixel are processed in each of the signal processing circuits 103. A signal processing circuit 103 is provided with a counter, a memory, and the like, and a digital value is held in the memory. In order to read out the signal from the memories for each pixel on which a digital signal has been held, the horizontal scanning circuit 111 inputs the control pulse that selects each column in order to the signal processing circuit 103.

A signal is output to the vertical signal line 113 from the signal processing circuits 103 of the pixels from a row selected by the vertical scanning circuit 110. The signal that has been output to the vertical signal line 113 is output externally from the sensor unit 100 via the readout circuit 112, and the output circuit 114. The readout circuit 112 incorporates a plurality of buffers connected to each vertical signal line 113.

As shown in FIG. 2 and FIG. 3, a plurality of the signal processing circuits 103 are arranged in a region that overlaps with the pixel region 12 in the planar view. In addition, the vertical scanning circuit 110, the horizontal scanning circuit 111, the readout circuit 112, the output circuit 114, and the control pulse generating unit 115 are arranged in the region outside the pixel region 12 of the sensor unit substrate 11 so as to overlap in a planar view.

That is, the sensor unit substrate 11 comprises the pixel region 12 and a non-pixel region arranged in the periphery of the pixel region 12. In addition, the vertical scanning circuit 110, the horizontal scanning circuit 111, the readout circuit 112, the output circuit 114, and the control pulse generating unit 115 are arranged in a region that overlaps the non-pixel region in the planar view.

It should be noted that the arrangement of the vertical signal line 113, the readout circuit 112, and the output circuit 114 is not limited to the example shown in FIG. 3. For example, the vertical signal line 113 may be arranged so as to extend in the row direction, and the readout circuit 112 may be arranged at the end of the vertical signal line 113.

In addition, a signal processing circuit 103 does not necessarily need to be provided such that there is one per each of the photoelectric conversion units, and a configuration may also be employed in which one signal processing circuit is shared by a plurality of photoelectric conversion units, and signal processing is performed sequentially.

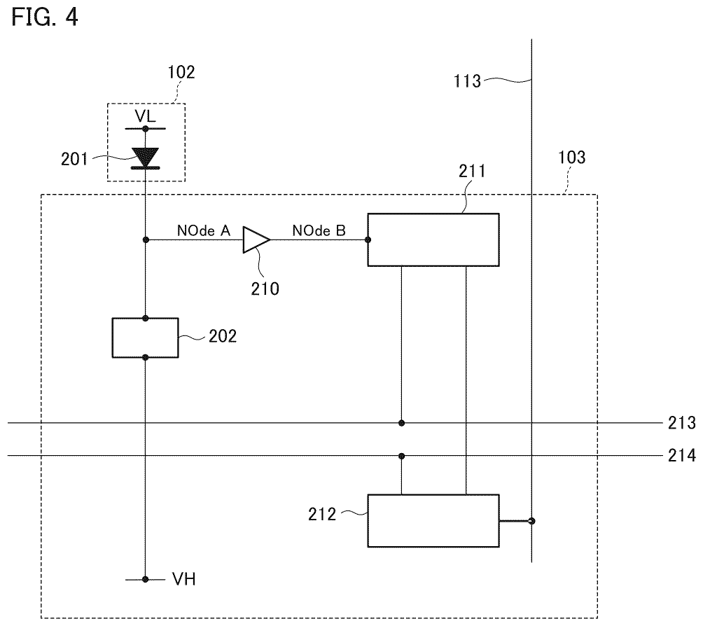

FIG. 4 is a diagram showing the equivalent circuit of the photoelectric conversion unit 102 and the signal processing circuit 103 corresponding to the photoelectric conversion unit 102 in FIG. 2 and FIG. 3. It should be noted that a photoelectric conversion unit 102 and a signal processing circuit 103 are included in each pixel. An APD 201 that is included in the photoelectric conversion unit 102 generates a charge pair corresponding to incident light from the photoelectric conversion.

One of the nodes from among the two nodes of the APD 201 is connected to a power supply line that supplies a drive voltage VL (a first voltage). In addition, the other node from among the two nodes of the APD 201 is connected to a power supply line that supplies a drive voltage VH (a second voltage) that is higher than the voltage VL.

In FIG. 4, the first node of the APD 201 is an anode, and the other node of the APD is a cathode. The anode and cathode of the APD 201 are supplied with reverse bias voltages such that the APD 201 performs an avalanche multiplication operation. By making a state in which such a voltage is supplied, the electric charge caused by the incident light undergoes avalanche multiplication, and an avalanche current is generated.

Note that in a case in which a reverse bias voltage is supplied, there is a Geiger mode that operates with a voltage difference between the anode and cathode larger than the breakdown voltage, and a linear mode that operates with a voltage difference between the anode and cathode in the vicinity of or less than the breakdown voltage. The APD that is operated in the Geiger mode is called a SPAD. In the case of the SPAD, for example, the voltage VL (the first voltage) is −30V, and the voltage VH (the second voltage) is 1V.

The signal processing circuit 103 includes a quench element 202, a waveform shaping unit 210, a counter circuit 211, and a memory 212. The quench element 202 is connected to the power supply line from which the drive voltage VH is supplied and one node from among the anode and cathode of the APD 201.

The quench element 202 functions as a load circuit (a quenching circuit) at the time of signal amplification due to the avalanche multiplication, and has a function for controlling the voltage that is supplied to the APD 201, and controlling the avalanche multiplication (a quenching function). In addition, the quench element 202 has a function that returns the voltage that is supplied to the APD 201 to the drive voltage VH by sending an electric current for the portion that was voltage dropped by the quenching function (a recharging function).

In FIG. 4, an example has been shown in which the signal processing circuit 103 includes the waveform shaping unit 210, the counter circuit 211, and the memory 212 in addition to the quench element 202. The waveform shaping unit 210 shapes the voltage change of the cathode of the APD 201 that is obtained when a photon is detected and outputs a pulse signal.

For example, an inverter circuit is used as the waveform shaping unit 210. In FIG. 4, an example has been shown in which one inverter is used as the waveform shaping unit 210. However, a circuit in which a plurality of inverters has been serially connected may also be used, or another circuit having a waveform shaping effect may also be used.

The counter circuit 211 counts the pulse signals that have been output from the waveform shaping unit 210, and holds a count value. In addition, when a control pulse RES has been supplied via a drive line 213, the signal that has been held in the counter circuit 211 is reset. Here, the counter 211 generates a signal based on the difference in count values at the start time and end time of the accumulation period.

The control pulse SEL is supplied from the vertical scanning circuit 110 in FIG. 3 to the memory 212 via a drive line 214 (not illustrated in FIG. 3) in FIG. 4 to switch the electrical connection or disconnection between the counter 211 and the vertical signal line 113. The memory 212 functions as a memory for temporarily storing the count value of the counter and outputs output signals from the counter 211 of the pixel to the vertical signal line 113.

It should be noted that a switch such as a transistor or the like may also be arranged between the quench element 202 and the APD 201, and between the photoelectric conversion unit 102 and the signal processing circuit 103, and electric connection may be switched on and off. In the same manner, the supply of the voltage VH or the voltage VL that are supplied to the photoelectric conversion unit 102 may also be electrically switched on and off by using a switch such as a transistor.

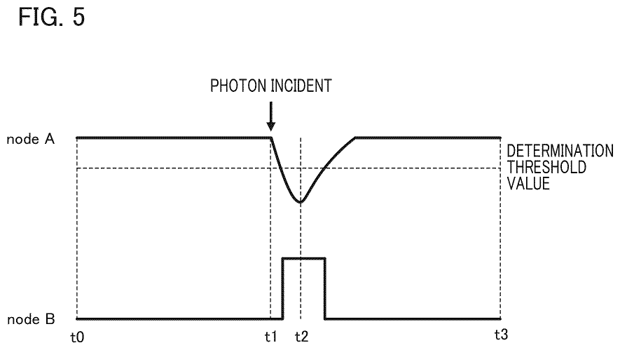

FIG. 5 is a diagram schematically showing the relationship between the operations of the APD 201 and the output signal. The input side of the waveform shaping unit 210 is denoted by node A, and the output side is denoted by node B. Between the time t₀ and the time t₁, a potential difference VH-VL is applied to the APD 201. When photons enter the APD 201 at time t₁, avalanche multiplication occurs in the APD 201, an avalanche multiplication current flows through the quenching element 202, and the voltage of the node A drops.

As the voltage drop amount further increases and the potential difference applied to the APD 201 becomes smaller, the avalanche multiplication of the APD 201 stops as at time t₂, and the voltage level of node A stops dropping below a certain value.

After this, between the time t₂ and the time t₃, an electric current that corrects the voltage drop portion flows through the node A from the voltage VL, and at the time t₃, the node A is statically determined at the original potential level. At this time, the portion in the node A for which the output waveform has exceeded a certain threshold is waveform shaped by the waveform shaping unit 210, and is output as a pulse signal from the node B.

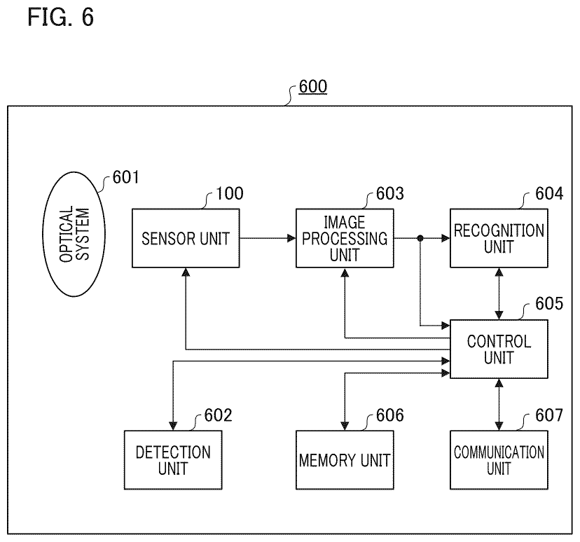

Next, the First Embodiment of the photoelectric conversion apparatus 600 will be explained. FIG. 6 is a functional block diagram of the photoelectric conversion apparatus 600 according to the First Embodiment. It should be noted that some of the functional blocks as shown in FIG. 6 are realized by causing a computer (not shown) included in the photoelectric conversion device 600 to execute a computer program that is stored in a memory serving as a storage medium (not shown).

However, a portion or the entirety thereof may also be made so as to be realized by hardware. An Application Specific Integrated Circuit (ASIC) and a processor (a reconfigurable processor, a DSP), and the like can be used as hardware.

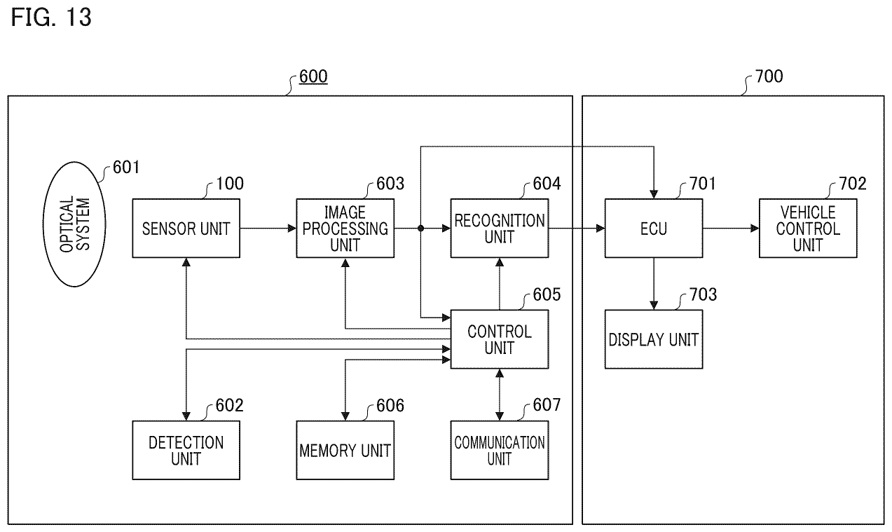

In addition, each of the functional blocks that are shown in FIG. 6 do not need to be incorporated in the same body, and they may also be configured by separate apparatuses that have been connected to each other via a signal path. It should be noted that the above explanation with respect to FIG. 6 is applicable to FIG. 13 explained later in the same manner.

The photoelectric conversion apparatus 600 includes the sensor unit 100 explained in FIG. 1 to FIG. 5, an optical system 601, a detection unit 602, an image processing unit 603, a recognition unit 604, a control unit 605, a storage unit 606, a communication unit 607, and the like. The sensor unit is configured by an avalanche photodiode for photoelectrically converting an optical image as explained in FIG. 1 to FIG. 5.

The camera unit consisting of the set of the optical system 601 and the sensor unit 100 is configured to capture, for example, at least one direction of the front, rear, or side of the photoelectric conversion apparatus 600.

In the Present Embodiment, the optical system 601 is a wide-angle lens (for example, a fish-eye lens) having an angle of view of, for example, 120 degrees, and forms an optical image (subject image) of an object in front of the photoelectric conversion apparatus 600 onto the image-capturing plane of the sensor unit 100. The detection unit 602 detects information (hereinafter referred to as environmental information) with respect to the surrounding environment of the photoelectric conversion apparatus 600. In addition, according to the output of the detection unit 602, changes in the position and size of an attention region and a non-attention region explained later are performed.

The image processing unit 603 performs image processing such as, for example, black level correction, gamma correction, noise reduction, digital gain adjustment, demosaic processing, data compression, and the like, on the image signal acquired by the sensor unit 100, and generates a final image signal. In a case in which the sensor unit has an on-chip color filter such as RGB, the image processing unit 603 performs processing such as white balance correction and color conversion.

In addition, the output of the image processing unit 603 is supplied to the recognition unit 604 and the control unit 605. The recognition unit 604 recognizes image-captured persons, vehicles, objects, and the like by performing image recognition based on the image signal. The recognition result by the recognition unit 604 is output to the control unit 605 and is reflected in the changes of the control modes of the photoelectric conversion apparatus 600 and the like. Furthermore, the recognition result is stored in the storage unit 606 and transmitted externally via the communication unit 607 and the like.

The control unit 605 incorporates a CPU serving as a computer and a memory that stores a computer program. In addition, the control unit 605 also functions as a setting unit, and the control unit 605 sets the length of the exposure period for each frame of the sensor unit 100 and the timing of the control signal CLK for each region via the control pulse generating unit 115 of the sensor unit 100.

Furthermore, the control unit 605 also functions as an acquisition unit, and acquires sensor characteristic information such as the size and number of pixels of the sensor unit 100, and optical characteristic information such as the angle of view and resolution of the optical system 601 as characteristic information of the photoelectric conversion apparatus 600. In addition, the control unit 605 acquires, as installation information of the photoelectric conversion apparatus 600, information such as installation height and installation angle from the detection unit 602, as well as environmental information with respect to the surrounding environment of the photoelectric conversion apparatus 600 from the detection unit 602.

Then, based on the information acquired from the detection unit 602, the CPU executes a computer program stored in the memory that has been incorporated in the control unit 605, thereby performing the control of each unit of the photoelectric conversion apparatus 600.

The storage unit 606 includes, for example, recording media such as a memory card, a hard disk, and the like, and the storage unit 606 can store and read out an image signal. The communication unit 607 is provided with a wireless or wired interface, and outputs the generated image signal to the outside of the photoelectric conversion apparatus 600 as well as receiving various signals from the outside.

The photoelectric conversion apparatus 600 is used, for example, as a camera, an in-vehicle camera, a pet camera, a monitoring camera, a camera used for performing detection and inspection in a manufacturing line, a logistics camera, and the like. In addition, the photoelectric conversion apparatus 600 can be applied to various uses such as a medical endoscope camera, a caregiving status detection camera, an infrastructure inspection camera, an agricultural camera, and the like.

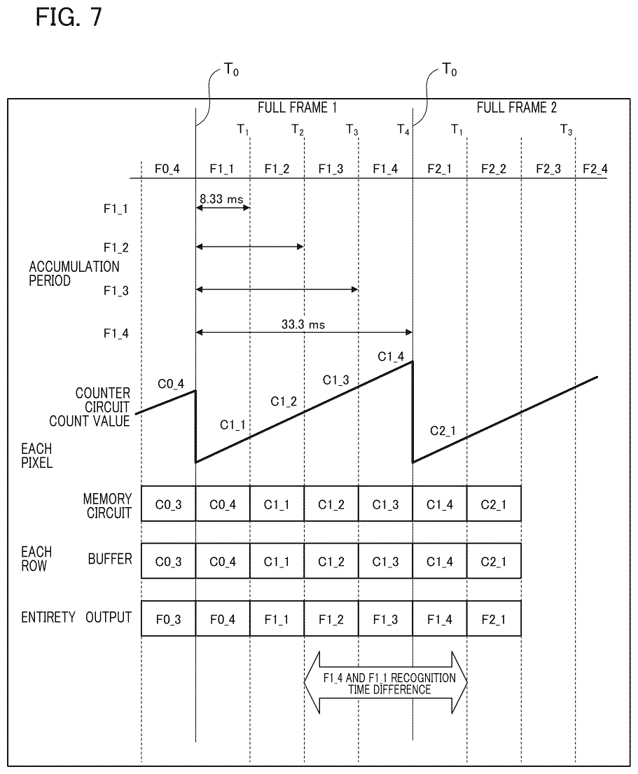

FIG. 7 is a diagram for explaining a photoelectric conversion method by the control unit 605 according to the First Embodiment. In the Present Embodiment, the photoelectric conversion is periodically driven at, for example, 30 full frames/second. A frame period having a vertical period length of 33.3 ms is referred to as a “full-frame period,” and each of the four parts into which a full-frame period is divided is referred to as a “frame.”

That is, as shown in FIG. 7, a full frame 1 is divided into frames 1_1, 1_2, 1_3, and 1_4, each having an equal period (8.33 ms). Note that in and after FIG. 7, there may be cases in which “frame” is abbreviated as “F”.

It should be noted that, frame 1_1 has an accumulation period from the start time T₀ to time T₁ of the full frame 1, frame 1_2 has an accumulation period from time T₀ to time T₂, frame 1_3 has an accumulation period from time T₀ to time T₃, and frame 1_4 has an accumulation period from time T₀ to time T₄.

Then, at times T₁ to T₄, count values C1_1, C1_2, C1_3, and C1_4 are each acquired from the counter 211. In addition, the count values C1_1, C1_2, C1_3, and C1_4 are temporarily stored in the memory 212.

Then, the signals of one line that have been temporarily stored in the memory 212 are sequentially output from the sensor unit via the buffer of the readout circuit 112. In addition, at time T₀, the counter 211 is reset. Thus, according to the Present Embodiment, the signals accumulated during the period of frame 1_1 are read out from time T₁ to time T₂ and are promptly processed by the recognition unit 604.

Therefore, image recognition can be promptly performed. Similarly, the signals accumulated during the periods of frame 1_2, frame 1_3, and frame 1_4 are sequentially read out from times T₂ to T₃, T₃ to T₄, and T₄ to T₁, respectively, and image recognition can be repeatedly performed. It should be noted that the length of a full-frame period is not limited to the above example. In addition, the number of divisions of a full-frame period is not limited to four.

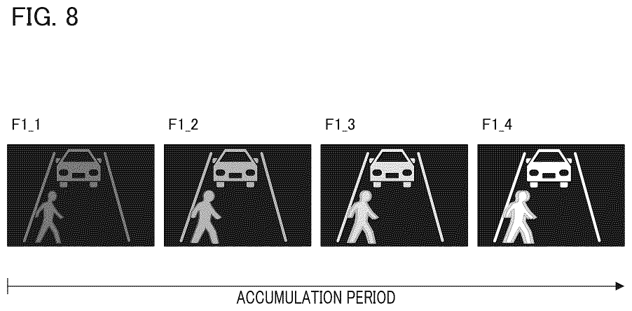

FIG. 8 is a diagram showing an example of images of a plurality of divided accumulation periods according to the First Embodiment. As shown in FIG. 8, although the image of frame 1_1 becomes dark because the accumulation period is short, there is less motion blur for a person who has suddenly stepped out. In contrast, as the accumulation period becomes longer in the order of frame 1_2, frame 1_3, and frame 1_4, motion blur is more likely to occur. It should be noted that, for stationary objects such as vehicles or white lines, blur is less likely to occur, and the longer the accumulation period, the more the contrast tends to improve.

Thus, in the Present Embodiment, within one full-frame period having a first accumulation period (for example, times T₁ to T₂) and a second accumulation period (for example, times T₁ to T₄), the first accumulation period is shorter than the second accumulation period. In addition, the signal generated during the first accumulation period is controlled so as to be output during the period from the end of the first accumulation period to the end of the second accumulation period.

In addition, in the Present Embodiment, the first accumulation period and the second accumulation period overlap, and the first accumulation period and the second accumulation period start simultaneously. Furthermore, the end of the second accumulation period coincides with the end of the full-frame period, and the second accumulation period is an integer multiple of the first accumulation period.

However, the second accumulation period does not need to be an integer multiple of the first accumulation period. The second accumulation period need only be longer than the first accumulation period (the first accumulation period being shorter than the second accumulation period), and the end of the second accumulation period need only be later than the end of the first accumulation period.

That is, an image with a short accumulation period and an image with a long accumulation period are created, and the timing at which the short accumulation period ends is made earlier than the timing at which the long accumulation period ends, and as soon as the short accumulation period ends, the image is output and sent to the subsequent recognition unit 604.

Then, at least a subject is recognized based on the signal generated in the first accumulation period. The recognition unit 604 recognizes the subject based on the signal generated in at least the first accumulation period. Therefore, while conventionally, image recognition could not be performed until one full frame period had elapsed, in the Present Embodiment, it becomes possible to perform image recognition after a minimum of ¼ of a full frame period.

It should be noted that an image having a long accumulation period can improve contrast, and thus can be used as a display image. That is, images having short accumulation periods are suitable for prompt subject recognition, while images having long accumulation periods are suitable for display images. Therefore, a display unit 703 of the Present Embodiment displays an image having a long accumulation period, that is, the signal generated in the second accumulation period, as a display image.

In addition, in the Present Embodiment, because an APD is used, unlike a CMOS image sensor, the accumulated charge does not degrade when read out, and the accumulation periods can overlap. Moreover, because there is no readout noise, even if a plurality of readings are performed in one accumulation period, the original signal does not degrade.

In contrast, in a CMOS image sensor, although it is possible to shorten the accumulation period by increasing the frame frequency, each time the accumulation period is shortened, readout noise overlaps, worsening the signal-to-noise ratio (S/N) of the output. Therefore, it becomes difficult to acquire an image suitable for image recognition.

In addition, in a CMOS image sensor, because it is necessary to re-accumulate the same charge in the pixel after readout so as to overlap accumulation periods, the circuit becomes complicated and the circuit size increases. Furthermore, because noise is superimposed when the charge is re-accumulated in the pixel, the S/N of the output significantly worsens, making it difficult to acquire an image suitable for image recognition.

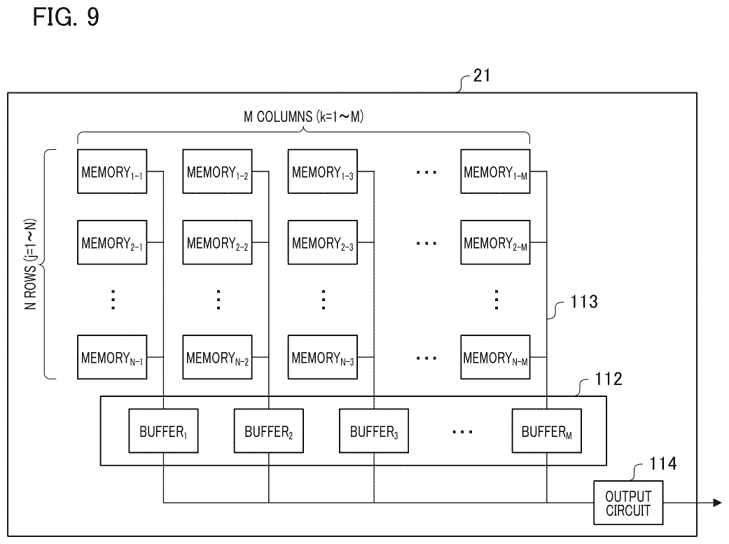

FIG. 9 is a diagram showing the relationship between memories and buffers in the First Embodiment. In FIG. 9, the memories 212 in the signal processing circuit 103 of FIG. 3 are shown in an N row by M column arrangement, and each memory 212 is represented as memory₁₋₁ to memory_{N-M}.

In addition, buffer to buffer in FIG. 9 represent the buffers included in the readout circuit 112 in FIG. 3. The output circuit 114 in FIG. 9 corresponds to the output circuit 114 in FIG. 3.

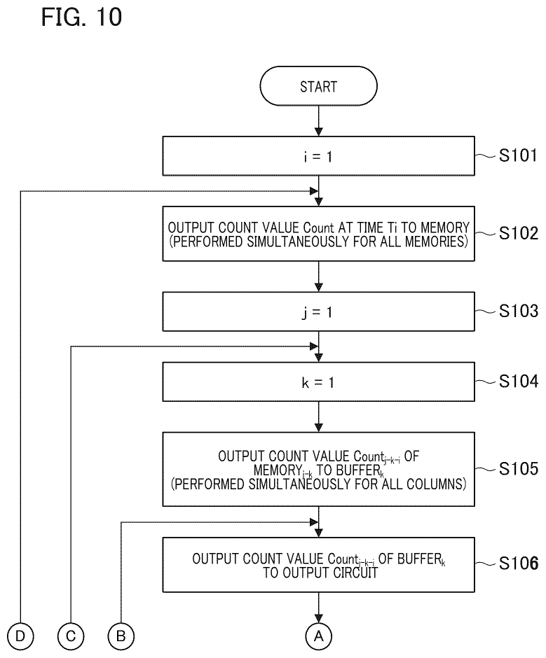

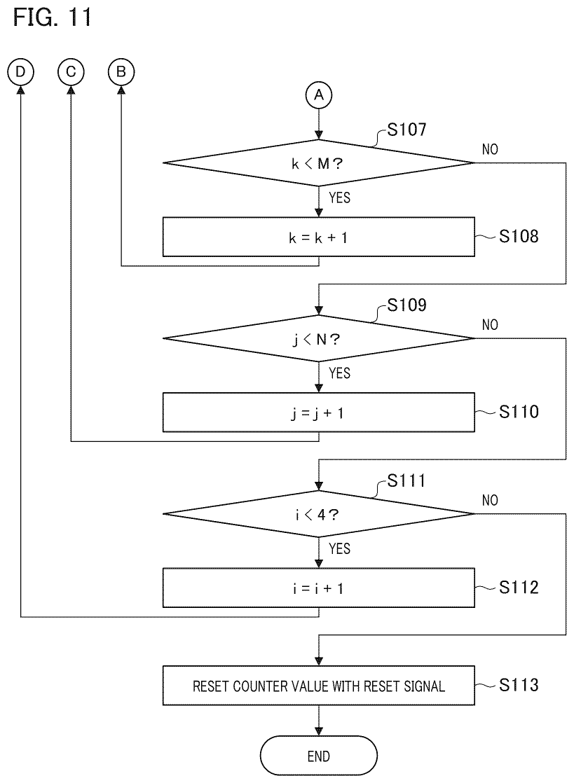

FIG. 10 is a flowchart showing details of a driving example of the sensor unit 100 in the First Embodiment, and FIG. 11 is a continuation of the flowchart in FIG. 10. It should be noted that by executing a computer program stored in the memory, the CPU serving as a computer within the control unit 605 sequentially performs the operations of each step in the flowcharts of FIG. 10 and FIG. 11.

In step S101 of FIG. 10, the CPU of the control unit 605 sets i=1. Next, in step S102, the CPU of the control unit 605 causes the count value Count of the counter 211 at time Ti to be output to the memory 212. At this time, output is performed simultaneously for all memories. This operation corresponds to the operation at time T₁ in FIG. 7.

Next, in step S103, the CPU of the control unit 605 sets j=1. Next, in step S104, the CPU of the control unit 605 sets k=1. In step S105, the CPU of the control unit 605 causes the count value Count (j-k-i) in the memories j-k of FIG. 9 to be output to the buffers. At this time, output is performed simultaneously to the buffers of columns 1 to M. This operation corresponds to the operation of loading the count value of the first row in FIG. 9 into the buffers.

In step S106, the CPU of the control unit 605 causes the count value Count (j-k-i) of buffer k to be output to the output circuit 114. This operation corresponds to the operation of reading out the signal of the buffer in the leftmost column of FIG. 9 from the output circuit.

Next, the processing proceeds to step S107 of FIG. 11 via A, and in step S107, the CPU of the control unit 605 determines whether k<M. If “Yes” in step S107, the CPU of the control unit 605 increments k by 1 (k=k+1) in step S108, then the processing returns to step S106 via B and the operation of step S106 is performed. This operation corresponds to the operation of reading out the signal of the buffer of the second column from the left in FIG. 9 from the output circuit.

In a case in which step S107 becomes “No,” that is, in a case in which k=M, this means that the reading out of the signal of the buffer of the M-th column in FIG. 9 from the output circuit has finished, and next, the processing proceeds to step S109, and the CPU of the control unit 605 determines whether j<N. In a case in which the decision in step S109 is “Yes,” the CPU of the control unit 605 sets j=j+1 and increments j by 1 in step S110, then the processing returns to step S104 via C. This operation corresponds to the operation for starting the reading out of the next row.

In a case in which the decision at step S109 is “No,” because this means that the reading out of all rows has finished, the processing proceeds to step S111, and the CPU of the control unit 605 determines whether or not i<4. In a case in which the decision in step S111 is “Yes,” the CPU of the control unit 605 sets i=i+1 and increments i by 1 in step S112, then the processing returns to step S102 via D. This operation corresponds to the operation to start the reading out at the next time T₂.

In a case in which “No” has been determined in step S111, because this means that the reading out at time T4 has completed, the processing proceeds to step S113, and the CPU of the control unit 605 resets the counter 211 by a reset signal. This operation corresponds to the operation to reset the counter 211 at time T4 in FIG. 7. It should be noted that the flows in FIG. 10 and FIG. 11 are periodically repeated. In this manner, the signals accumulated in the sensor unit can be sequentially read out.

In the sensor unit, in the case of the circuit configuration shown in FIG. 9, it becomes possible to change the setting of the accumulation period of each column.

For example, in the first column (k=1), during the period of full frame 1, as described in FIG. 7, it becomes possible to change the accumulation period and read out the four pieces of data of frame 1_1, frame 1_2, frame 1_3, and frame 1_4. That is, the first column is set as a first image region with a short accumulation period.

In contrast, in the second column (k=2), it becomes possible to divide the period of full frame 1 into two and read out only the two pieces of data of frame 1_2 and frame 1_4. In other words, the second column is set as a second image region having a long accumulation period.

Thus, according to the Present Embodiment, the accumulation period and the number of accumulations can be arbitrarily changed, and by changing the accumulation period and the number of accumulations, it becomes possible to change the intensity of the accumulated signal and increase or decrease the number of accumulations. Moreover, the amount of data can be increased or decreased according to the number of accumulations. However, if the amount of data increases, the power consumption of the sensor unit and the photoelectric conversion apparatus 600 also increases accordingly.

The change of the setting of an accumulation period is not limited to the method of changing each column, and it is also possible to change the setting of the accumulation period for each row by changing the signal lines of the sensor unit 100, or to change the setting of the accumulation period for each pixel. This setting of the accumulation period for each region or each pixel is performed by the control unit 605.

As described above, the control unit 605, which incorporates a CPU serving as a computer and a memory that stores a computer program, acquires information from the detection unit 602, and based on that information, the CPU executes the computer program stored in the memory. Accordingly, it is possible to perform the setting of the accumulation period for each region or each pixel.

Thus, the control unit 605 sets the accumulation period for each region or pixel of the sensor unit 100, and the timing at which the short accumulation period ends can be made earlier than the timing at which the long accumulation period ends. Therefore, as soon as the short accumulation period ends, it becomes possible to output the image and send the image to the subsequent recognition unit 604.

That is, based on the signal that is generated during the first accumulation period, subject recognition by the recognition unit 604 becomes possible in the image region having a short accumulation period at time T₁, which is the time at which frame 1_1 ends and is earlier than the time T₄ at which the full frame 1 ends, in the first column (k=1). Therefore, while conventionally, image recognition could not be performed until one full frame period had elapsed, in the Present Embodiment, it becomes possible to set a region in which image recognition can be performed in a shorter time.

In addition, because it becomes possible to acquire images in a plurality of accumulation periods, it becomes possible to generate images that are appropriately exposed for both the bright regions and the dark regions. Accordingly, the signal-to-noise ratio (S/N) of each region can be maximized. That is, in dark regions, the signal is increased in a long accumulation period, and it is possible to maximize the S/N.

In contrast, in bright regions, it is possible to acquire the signal without saturating the signal in a short accumulation period, and it is possible to maximize the S/N. Therefore, by applying an accumulation period suitable for each region, it becomes possible to acquire images in which the signal is not saturated and noise is suppressed, thereby maximizing the S/N for each region.

In addition, by applying an accumulation period suitable for each region, it becomes possible to suppress blur with respect to the movement of a subject. In a long accumulation period, there is a possibility that the image of the subject will be blurred (motion blur). In contrast, in a short accumulation period, it is possible to reduce the blurring of the subject. Therefore, by applying an appropriate accumulation period, it becomes possible to acquire an image in which blur with respect to the movement of the subject has been reduced.

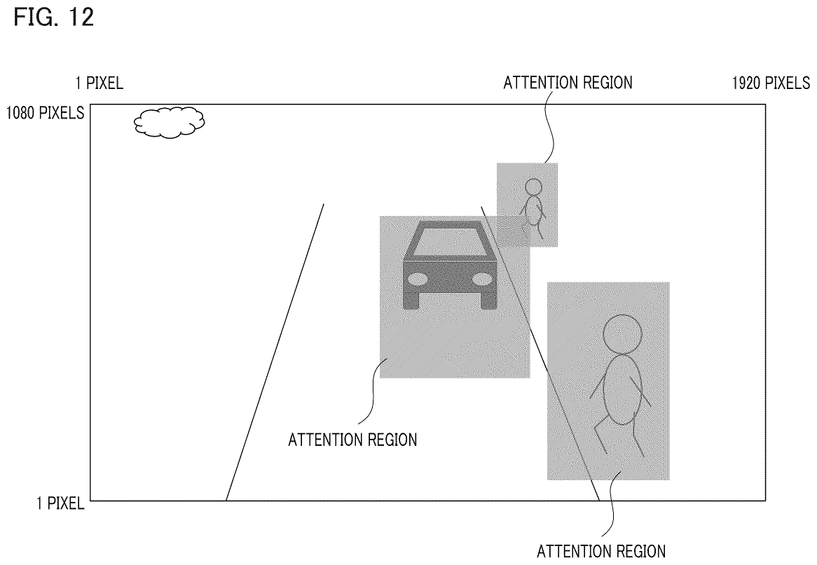

FIG. 12 is a diagram explaining an example of setting an attention region with respect to a movable apparatus in the First Embodiment. For example, first, a movable apparatus in the image capturing region is recognized, and the surroundings thereof are set as an attention region. FIG. 12 shows an image captured by the photoelectric conversion apparatus 600. This photoelectric conversion apparatus 600 includes an optical system 601 that has a horizontal angle of view of 120 degrees and a vertical angle of view of 30 degrees. In addition, the number of pixels in the sensor unit 100 is 1920 pixels in the M column direction and 1080 pixels in the N row direction.

In the image capturing region shown in FIG. 12, based on the signal that is read out from the pixel region of the sensor unit 100 and is image-processed by the image processing unit 603, the recognition unit 604 recognizes whether any moving bodies are captured. Specifically, a comparison of images captured by the sensor unit 100, for example, for each full-frame period, is performed, and regions in which there is a temporal change of the image are recognized as moving bodies.

Then, upon recognizing a movable apparatus, a first pixel region, as an attention region, is set for the surroundings thereof or in the direction of movement thereof, as shown shaded in gray in FIG. 12. In the first pixel region, at least the first accumulation period and the second accumulation period are included.

Here, the control unit 605 functions as a setting unit capable of setting a first pixel region having at least the first accumulation period and the second accumulation period, and a second pixel region having at least the second accumulation period, in the sensor unit consisting of a plurality of pixels. In the Present Embodiment, the control unit 605 sets the first pixel region and the second pixel region based on the image that has been read out from the sensor unit.

Accordingly, in the Present Embodiment, the surroundings of a movable apparatus are set as the first pixel region to serve as the attention region, and by acquiring an image in the first accumulation period that is shorter than the full frame period, it becomes possible to obtain an image of a movable apparatus with high S/N and minimal motion blur.

Furthermore, by acquiring such an image, in a case in which recognizing the movable apparatus and tracking the movable apparatus as an image capture target and the like are performed, it becomes possible to recognize the movable apparatus accurately, and it is possible to properly capture and record the movable apparatus as an image capture target.

In contrast, for regions other than a region surrounding the movable apparatus, it is sufficient if they are captured as background images, and images with high S/N or minimal blur are often not required. Therefore, these regions are set as second pixel regions, serving as non-attention regions, and by acquiring images during the second accumulation period, which is longer than the first accumulation period, within the full frame period, it becomes possible to reduce the number of data of the captured images.

Thus, in the Present Embodiment, based on the images captured and generated by the photoelectric conversion apparatus 600, it is determined as to whether or not there are moving bodies, and in accordance with the determination result, the first pixel region and the second pixel region are set, and image capturing is performed for each region in different accumulation periods. Accordingly, it is possible to recognize moving bodies in images earlier than the full frame period. Furthermore, it becomes possible to reduce both the number of data and power consumption while maintaining high S/N and reducing pixel blur due to motion.

That is, it is possible to provide a photoelectric conversion apparatus that can set an attention region in the image capturing range and read out the image data of a relatively short accumulation period midway in that attention region.

### Second Embodiment

Next, a Second Embodiment is explained, in which a specific person, animal, or the like within the image capturing region is recognized, and the surroundings thereof are set as an attention region.

In the image capturing region, the recognition unit 604 recognizes, from the image generated by using the signals read out from the pixel region of the sensor unit 100, whether a specific person or animal registered in advance has been captured. As a method of recognition, the face of the person or animal is evaluated based on the positions and sizes of feature points such as the eyes, nose, and mouth. Then, in a case in which the specific person or animal is recognized, a first pixel region, as an attention region, is set for the surroundings thereof.

For this purpose, in the case of a general camera, faces of family or friends, or faces of pets in a pet camera, and the like, are registered in advance. In addition, in the case of a monitoring camera and the like, features such as the face and physique of a person being monitored are registered in advance. Alternatively, features such as the face and physique of the person being monitored that have been registered in advance may be acquired from an external server and the like.

Accordingly, by setting the surroundings of a specific person, animal, or the like as the first pixel region, serving as the attention region, and acquiring an image in the first accumulation period that is shorter than the full frame period, it becomes possible to acquire an image in which the S/N of the movable apparatus is high and in which motion blur is minimal.

Furthermore, by acquiring such an image, in a case of recognizing the specific person, animal, or the like, and automatically tracking the specific person, animal, or the like as an image capture target, it becomes possible to recognize the specific person, animal, or the like accurately, and it is possible to appropriately capture and record the specific person, animal, or the like as an image capture target.

In contrast, for regions outside the attention region, it is sufficient if these regions are captured as background images, and therefore, these regions are set as the second pixel regions, serving as non-attention regions, and by acquiring images in the second accumulation period within the full frame period, it becomes possible to reduce the number of data of the captured images.

Thus, in the Second Embodiment, a predetermined image is image recognized based on the images captured and generated by the photoelectric conversion apparatus 600, and based on the result thereof, a first pixel region and a second pixel region are set, and image capturing is performed in each region having a different accumulation period.

Accordingly, it is possible to acquire an image of an attention region at a timing earlier than the full frame period, and because the S/N is high and pixel blur due to motion is minimal, high-precision image recognition becomes possible. Furthermore, it becomes possible to reduce the number of data and power consumption.

In the above embodiment, a method in which persons or animals are registered in advance was explained. However, components, units, packaging labels, and the like may be registered for a factory production line, or tumors and abnormal parts may be registered for an endoscope camera, or monitoring targets may be registered for an infrastructure camera, or crops and the like may be registered for an agricultural camera.

Then, by setting a subject registered in advance as an attention region, and performing readout at an early timing in a short accumulation period, it becomes possible to maintain high S/N and reduce pixel blur due to motion, while also reducing the number of data and power consumption.

### Third Embodiment

Next, as a Third Embodiment, an example is explained in which, in a case in which the photoelectric conversion apparatus 600 is used by being mounted on the movable apparatus 700, a traffic participant target is recognized, and an attention region is set based on the recognition result. In the Present Embodiment, a traffic participation target refers to, for example, a person on the road such as a pedestrian and a movable apparatus such as a motorcycle, a bicycle, and the like around the movable apparatus.

Next, FIG. 13 is a functional block diagram showing a configuration example of the photoelectric conversion apparatus 600 and the movable apparatus 700 according to the Third Embodiment. The photoelectric conversion apparatus 600 of the Third Embodiment is mounted on the movable apparatus 700, and an attention region is set based on at least one of the position, speed, travel direction, or distance and the like of traffic participant targets such as people and vehicles. It should be noted that in FIG. 13, the same reference numerals as in FIG. 6 indicate the same functional blocks, and therefore, an explanation thereof is omitted.

In the Third Embodiment, the output of the image processing unit 603 is supplied to the recognition unit 604, the control unit 605, and an ECU (Electric Control Unit) 701 serving as the movement control unit of the movable apparatus 700. The recognition unit 604 recognizes people, vehicles, objects, and the like of the surroundings by performing image recognition based on the image signal, and outputs the recognition result to the ECU 701.

In addition, the control unit 605 acquires installation information such as the installation height and installation angle of the photoelectric conversion apparatus 600 on the movable apparatus 700 from the ECU 701. Furthermore, the control unit 605 acquires the environmental information of the photoelectric conversion apparatus 600 from the detection unit 602, and also acquires information and environmental information of the movable apparatus 700 from the ECU 701.

As information of the movable apparatus acquired from the ECU 701, at least one of vehicle speed information, acceleration information, steering angle information, brake information, engine information, and the like is included. In addition, as environmental information, at least one of presence or absence, position, speed, acceleration, and distance of traffic participant targets, map information, GPS information, road conditions, road surface status, weather information, brightness of surroundings, time, and the like is included.

Then, based on these acquired pieces of information, the CPU executes a computer program stored in the memory that has been incorporated in the control unit 605, thereby performing the control of each unit of the photoelectric conversion apparatus 600.

The ECU 701 incorporates a CPU serving as a computer and a memory that stores a computer program, and by executing the computer program stored in the memory, the CPU performs the control of each unit of the movable apparatus 700.

The output of the ECU 701 is also supplied to a vehicle control unit 702 and the display unit 703. The vehicle control unit 702 functions as a driving control unit that performs operations such as driving, stopping, and direction control of the vehicle serving as a movable apparatus, based on the output of the ECU 701.

In addition, the display unit 703, which includes display elements such as a liquid crystal device or an organic EL and the like, is mounted on the movable apparatus 700. The display unit 703, based on the output of the ECU 701, displays various types of information with respect to the driving state of the vehicle and images acquired by the sensor unit, and the like, for the driver of the movable apparatus 700 by using, for example, a GUI.

It should be noted that the image processing unit 603, the recognition unit 604, and the like in FIG. 13 do not necessarily need to be mounted on the movable apparatus 700. For example, they may be provided in an external terminal or an external server and the like, which is separate from the movable apparatus 700, for remotely controlling the movable apparatus 700 or monitoring the driving of the movable apparatus.

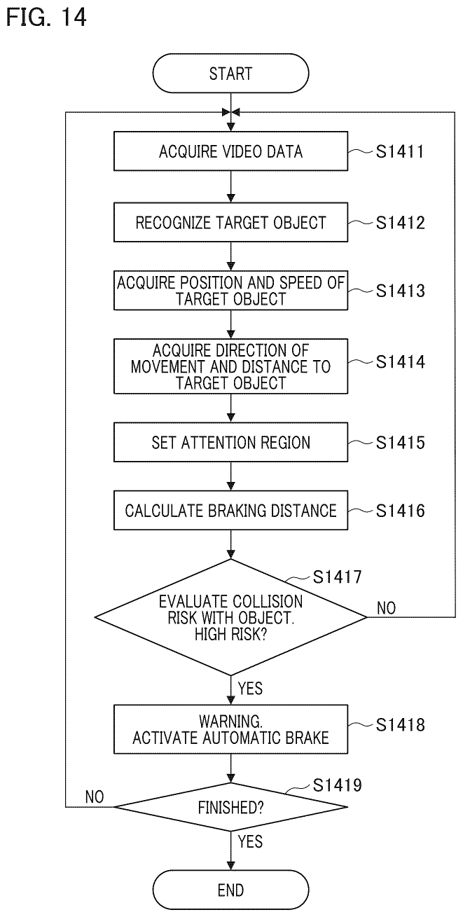

FIG. 14 is a flowchart explaining a control method for a movable apparatus according to the Third Embodiment. It should be noted that by executing a computer program stored in the memory, the CPU serving as a computer within the control unit 605 and the ECU 701 sequentially perform the operations of each step in the flowchart of FIG. 14.

First, in step S1411, the CPU of the control unit 605 acquires video data from the photoelectric conversion apparatus 600 during operation. Next, in step S1412, the CPU of the control unit 605 recognizes a target object as a traffic participant target by performing image recognition based on the signal read out from the pixel region of the sensor unit 100 of the photoelectric conversion apparatus 600.

Then, in step S1413, the CPU of the control unit 605 acquires the position and speed of the recognized target object serving as a traffic participant target or the like. This may be acquired by using changes in the object in the video data of multiple full frames or by using a separate distance measuring device such as millimeter-wave radar or LiDAR (Light Detection and Ranging).

Next, in step S1414, the CPU of the ECU 701 acquires the travel direction of the object that is the traffic participant target and the distance to the target object. Similar to the above, this information may be acquired by using changes in the target object in the video data of a plurality of full frames or by using a separate distance measuring device such as millimeter-wave radar or LiDAR.

Then, in step S1415, the CPU of the ECU 701 sets the attention region based on at least one of the position, speed, travel direction, or distance and the like of the target object, which is a traffic participant target or the like. Next, in step S1416, the braking distance of the own vehicle is calculated.

It should be noted that the braking distance is not limited to the speed of the movable apparatus 700 and varies depending on factors such as the inclination angle of the road surface, the condition of the road surface (asphalt, dirt, gravel, rain, snow, ice, and the like), the degree of tire wear (characteristics of the tire itself, usage distance, and the like), and the weight of the movable apparatus 700. Therefore, a determination may be made by using such information comprehensively.

Next, in step S1417, the CPU of the ECU 701 performs an evaluation of the collision risk with a target person that is the traffic participant target. At that time, the evaluation is performed by considering factors such as the speed, travel direction, and distance of the target person that is the traffic participant target.

Then, in step S1417, in a case in which it is determined that the collision risk is higher than a predetermined value, in step S1418, the CPU of the ECU 701 generates a warning signal and issues a warning to the driver via the display unit 703 and sound. Furthermore, an automatic braking system is activated according to necessity.

In addition, in a case in which it is determined in step S1417 that the collision risk is below the above-described predetermined value, the processing returns to step S1411, and the next video data of a full-frame period is acquired.

Next, after step S1418, the processing proceeds to step S1419, and the CPU of the ECU 701 determines whether the power of the movable apparatus has been turned off by the user or an operation for terminating the flow of FIG. 14 has been performed. If the determination in step S1419 is “Yes,” the flow of FIG. 14 is terminated. If the determination in step S1419 is “No,” the processing returns to step S1411, and the flow of FIG. 14 is repeated.

In this manner, by setting the surroundings of the traffic participant target as the first pixel region, serving as the attention region, and acquiring an image during the first accumulation period, which is shorter than the full frame period, it is possible to acquire an image in which the S/N of the movable apparatus is high, and in which motion blur due to movement is minimal.

Furthermore, by acquiring such an image, it becomes possible to recognize the traffic participant target, and to recognize the traffic participant target accurately in functions such as continuing to capture the traffic participant target as an image capture target. In addition, in a case in which the collision risk between the movable apparatus 700 and the traffic participant target is high, a warning signal is generated, and a warning is issued to the driver through the display unit 703 and sound, and furthermore, a collision prevention system such as an automatic braking system can be realized according to necessity.

In contrast, for regions other than the regions surrounding the traffic participant target, it is sufficient if they are captured as background images, and images with high S/N or minimal blur are often not required. Therefore, these regions are set as the second pixel region, serving as non-attention regions, and by acquiring images during the second accumulation period, which is longer than the first accumulation period, within the full frame period, it becomes possible to reduce the number of data of the captured images.

Thus, in the Third Embodiment, based on the images captured and generated by the photoelectric conversion apparatus 600, the traffic participant target is recognized, and based on the recognition result, a first pixel region and a second pixel region are set, and image capturing is performed for each region in different accumulation periods. Accordingly, it becomes possible to recognize images earlier than the full frame period, and it becomes possible to reduce both the number of data and power consumption while maintaining high S/N and reducing pixel blur due to motion.

In addition, although the recognition of the traffic participant target has been explained based on the images captured and generated by the photoelectric conversion apparatus 600 in the Present Embodiment, the recognition is not limited to images, and distance measuring devices such as millimeter-wave radar or LiDAR may also be used. By using millimeter-wave radar or LiDAR, it is possible to more accurately obtain the travel direction and speed of the traffic participant target, and it becomes possible to more accurately perform the setting of the surrounding region of the traffic participant target.

### Fourth Embodiment

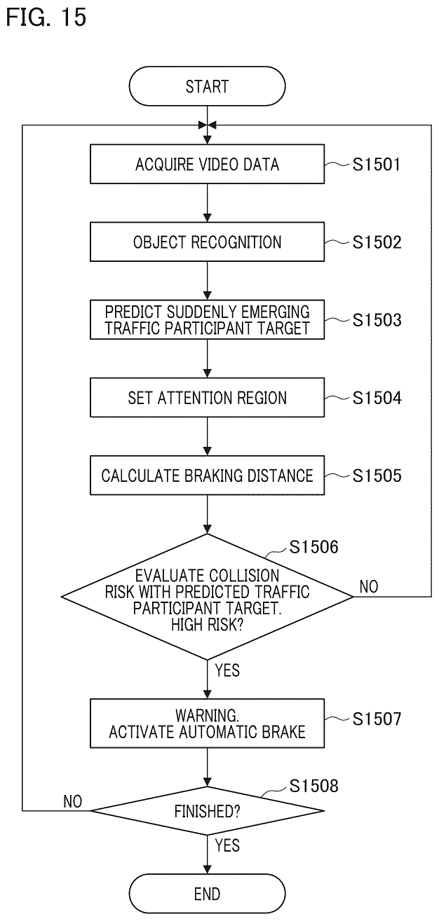

In a Fourth Embodiment, an example in which blind spot regions within the image capturing region are recognized, and the surroundings of each blind spot region and the traveling direction of the movable apparatus are set as an attention region, will be explained with reference to FIG. 15. FIG. 15 is a flowchart explaining a control method of the movable apparatus according to the Fourth Embodiment.

It should be noted that by executing a computer program stored in the memory, the CPU serving as a computer within the control unit 605 and the ECU 701 sequentially perform the operations of each step in the flowchart of FIG. 15.

First, in step S1501, the CPU of the control unit 605 acquires video data from the photoelectric conversion apparatus 600 during operation. Next, in step S1502, the CPU of the control unit 605 performs image recognition based on the signals read out from the pixel region of the sensor unit 100 of the photoelectric conversion apparatus 600, thereby recognizing the blind spot regions within the image capturing region serving as target objects.

A blind spot region in the Fourth Embodiment refers to a region in which a traffic participant target, which is not at all or is almost not at all captured in the images taken by the photoelectric conversion apparatus 600, may suddenly appear. That is, a region such as an intersection having poor visibility, the walls of a building and the like, the shadow of a vehicle other than the own vehicle, a sign and the like, and a tree and the like.

Upon recognizing a blind spot region within the capturing region, in step S1503, the CPU of the control unit 605 assumes that a traffic participant target may suddenly emerge from the blind spot region. Specifically, the traffic participant target is assumed based on factors such as the size of an object that could form a blind spot region, road conditions, and the like. For example, on a road dedicated to automobiles, it is sufficient to assume vehicles such as cars or motorcycles as traffic participant targets that may suddenly emerge, and for small trees or signs and the like, it is sufficient to assume traffic participant targets other than vehicles.

Furthermore, in step S1504, the CPU of the control unit 605 sets an attention region around a blind spot region according to the assumed traffic participant target, and sets a first pixel region as the attention region for each blind spot region. That is, in a case in which there is a high possibility that a vehicle may suddenly emerge from a blind spot region, the region is set large, and in a case in which there is a high possibility that the emerging traffic participant target is a pedestrian, the region is set small.

Next, in step S1505, the CPU of the ECU 701 calculates the braking distance of the movable apparatus 700. With respect to the braking distance, in addition to the speed of the movable apparatus 700, the braking distance varies depending on factors such as the inclination angle of the road surface, the condition of the road surface (asphalt, dirt, gravel, rain, snow, freezing, and the like), the degree of tire wear (characteristics of the tire itself, usage distance, and the like), and the weight of the movable apparatus 700. Therefore, a determination may be made by using such information comprehensively.

Next, in step S1506, the CPU of the ECU 701 performs an evaluation of the collision risk with a target person that is the assumed traffic participant target. At that time, the evaluation is performed by considering factors such as the speed, travel direction, and distance of the target person that is the traffic participant target.

Then, in step S1506, in a case in which it is determined that the collision risk is higher than a predetermined value, in step S1507, the CPU of the ECU 701 generates a warning signal and issues a warning to the driver via the display unit 703 and through sound. Furthermore, an automatic braking system is activated according to necessity.

In addition, in a case in which it is determined in step S1506 that the collision risk is below the above-described predetermined value, the processing returns to step S1501, and the next video data of a full-frame period is acquired.

Next, after step S1507, the processing proceeds to step S1508, and the CPU of the ECU 701 determines whether the power of the movable apparatus has been turned off by the user or an operation for terminating the flow of FIG. 15 has been performed. If the determination in step S1508 is “Yes,” the flow of FIG. 15 is terminated. If the determination in step S1508 is “No,” the processing returns to step S1501, and the flow of FIG. 15 is repeated.

In this manner, in the Fourth Embodiment, a blind spot region is recognized as a target object, the surroundings thereof are set as the first pixel region, serving as the attention region, and an image is acquired during an accumulation period shorter than the full frame period. Accordingly, it is possible to recognize the image of the blind spot region earlier than the full frame period, and it becomes possible to acquire the image of the blind spot region with high S/N and minimal motion blur.

Furthermore, by acquiring such an image of a blind spot region early, it becomes possible to recognize a traffic participant target that suddenly emerges from the blind spot region early with high precision, to determine the collision risk early, and to reduce the collision risk.

In contrast, for regions other than the surrounding regions of the blind spot regions, because the collision risk due to the sudden emergence of traffic participant targets and the like is low, it is often not necessary to recognize images earlier than the full frame period, or to acquire images with high S/N and minimal blur. Therefore, these regions other than the surrounding regions of the blind spot regions are set as second pixel regions, serving as non-attention regions, and by acquiring images during the second accumulation period, which is longer than the first accumulation period, within the full frame period, it becomes possible to reduce the number of data of the captured image.

Thus, in the Fourth Embodiment, based on the images captured and generated by the photoelectric conversion apparatus 600, blind spot regions are recognized, and based on the recognition result, first pixel regions and second pixel regions are set, and image capturing is performed for each region in different accumulation periods. Accordingly, it becomes possible to recognize images earlier than the full frame period, and furthermore, it becomes possible to reduce both the number of data and power consumption while maintaining high S/N and reducing pixel blur due to motion.

### Fifth Embodiment

Next, in a Fifth Embodiment, an example in which road conditions within the image capturing region are recognized, and an attention region is set according to the recognized road conditions, will be explained.

In the Fifth Embodiment, the recognition unit 604 recognizes information related to roads having high collision risk based on the image of the image capturing region. Here, information related to roads with high collision risk refers to intersections, opposing lanes, merging lanes, and the like. These roads are recognized from the image, and the surrounding regions of these roads are collectively set as an attention region.

Then, upon recognizing these roads having high collision risk within the image capturing region, a first pixel region as the attention region is set for each of the roads. It should be noted that information related to roads having high collision risk may also be acquired based on GPS information and map information, and the like. Furthermore, as attribute information of map information, information related to the location of roads with frequent past accidents, time zones, weather, dates, and the like, as well as at least one of current road construction status, congestion status, traffic accident occurrence status, and the like may be acquired from an external server.

As the setting method for an attention region, it is preferable to consider the potential movement direction and movement speed of traffic participant targets that may suddenly emerge from these roads and to set the region range according to the potential movement direction and movement speed. This is determined based on the type of traffic participant target that becomes a collision risk and road conditions and the like.

That is, at intersections, it is preferable to set a region that intrudes into the location in which the own vehicle is traveling straight or turning right or left, and in opposing lanes, it is preferable to set a large region considering the relative speed with the own vehicle, and in merging lanes, it is preferable to set a region that intrudes into the lane in which the own vehicle is traveling.

In this manner, in the Fifth Embodiment, the road surroundings having high collision risk are set as first pixel regions, serving as attention regions, and images are acquired during an accumulation period that is shorter than the full frame period. Accordingly, it is possible to recognize images of the road surroundings having high collision risk earlier than the full frame period, and it becomes possible to acquire images of the road surroundings with high S/N and minimal motion blur.

Furthermore, by acquiring such images early, it becomes possible to recognize traffic participant targets early and to assess the collision risk early with high precision, and the collision risk can be effectively reduced.

In contrast, for regions other than the surrounding regions of roads having high collision risk, because the collision risk with traffic participant targets is low, it is often not necessary to recognize images earlier than the full frame period, or to acquire images with high S/N and minimal blur. Therefore, these regions are set as second pixel regions, serving as non-attention regions, and by acquiring images during the second accumulation period, which is longer than the first accumulation period, within the full frame period, it becomes possible to reduce the number of data of the captured images.

Thus, in the Fifth Embodiment, based on road information, first pixel regions and second pixel regions are set, and image capturing is performed in each region during different accumulation periods, making it possible to recognize images earlier than the full frame period. Furthermore, it becomes possible to reduce both the number of data and power consumption while maintaining high S/N and reducing pixel blur due to motion.

It should be noted that in order to enhance the recognition accuracy of road conditions, by utilizing information such as map information and GPS-based location information, it becomes possible to achieve more accurate situational awareness by recognizing road conditions based on the combination of map information, GPS-based location information, and the images captured by the photoelectric conversion apparatus 600.

In addition, during straight-ahead driving, it is desirable to set an attention region based on information such as traffic participants in the forward direction, signals, speed limit signs, as well as intersections, lanes, shoulders, crosswalks, and other road information.

In addition, around intersections, traffic participant targets, signals, signs, and priority indicators of the travel direction often exist. Therefore, it becomes necessary to set an attention region that considers risks related to traffic participant targets hidden in various blind spot regions, and not limiting the setting of the attention region to the movement of recognized traffic participant targets. That is, in addition to information of road conditions, it is desirable to set the attention region based on blind spot region information and the like according to the Fourth Embodiment.

In addition, in parking lots, it is necessary to set an attention region that considers risks related to the movement of traffic participant targets in all directions, including to the rear as well as to the front, and traffic participant targets hidden in various blind spot regions.

### Sixth Embodiment

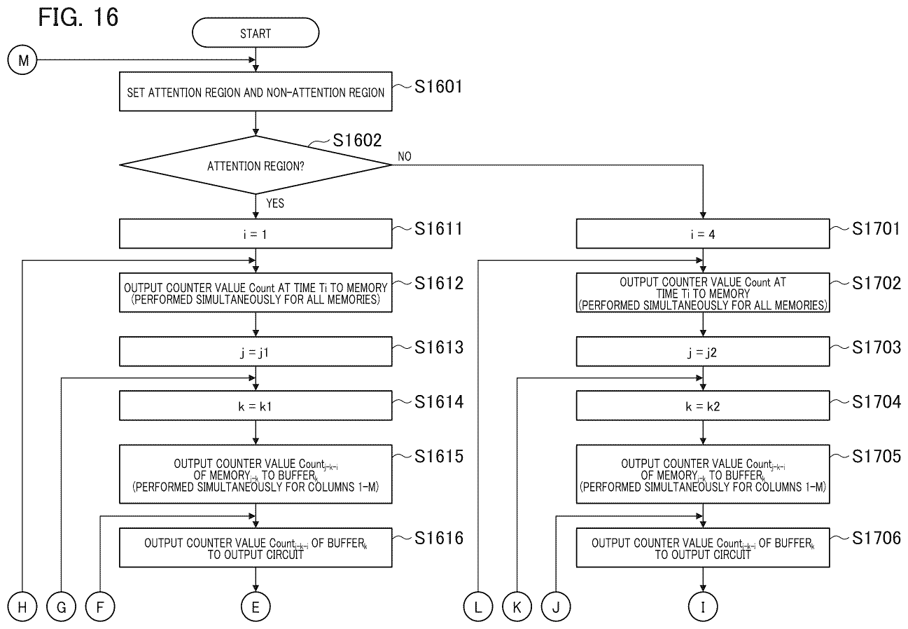

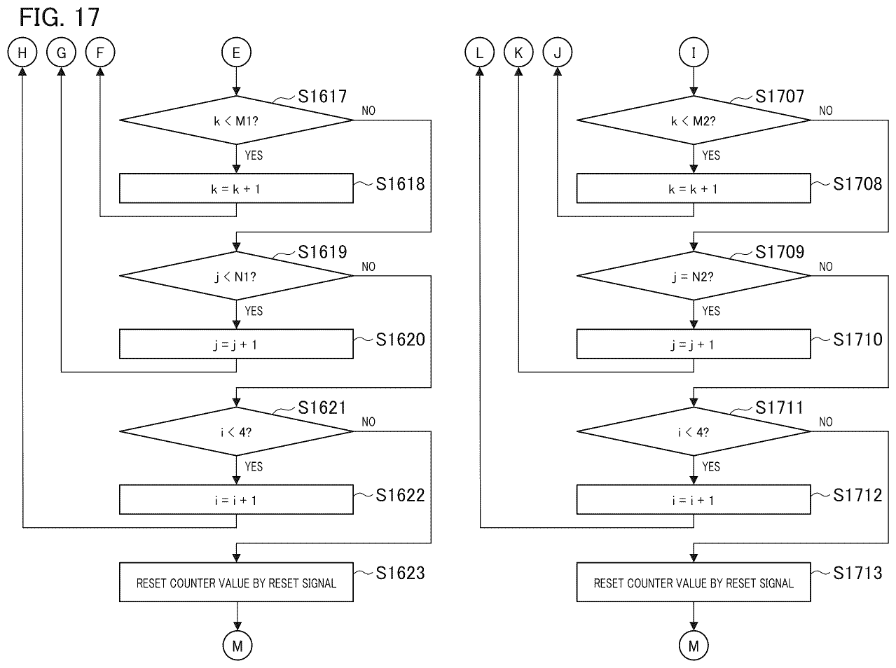

FIG. 16 is a flowchart showing details of a driving example of the sensor unit 100 with respect to the method of setting a region of interest according to a Sixth Embodiment, and FIG. 17 is a continuation of the flowchart of FIG. 16.

It should be noted that by executing a computer program that is stored in the memory, the CPU serving as a computer within the control unit 605 sequentially performs the operations of each step of the flowcharts of FIG. 16 and FIG. 17.

In step S1601, the CPU of the control unit 605 of the photoelectric conversion apparatus 600 sets an attention region and a non-attention region within the image capturing region based on the characteristic information related to the characteristics of the photoelectric conversion apparatus, the installation information of the photoelectric conversion apparatus, and the environmental information of the photoelectric conversion apparatus.

It should be noted that the control unit 605 may set a first pixel region or a second pixel region based on at least one of the characteristic information related to the characteristics of the photoelectric conversion apparatus, the installation information related to the installation state of the photoelectric conversion apparatus, and the environmental information related to the surrounding environment of the photoelectric conversion apparatus.

Furthermore, based on at least one of the above-described characteristic information, installation information, and environmental information, at least one of the position, size, or accumulation period of the first pixel region or the second pixel region may be set. In addition, the first pixel region or the second pixel region may be set so that the setting corresponds to the distance information of the subject.

It should be noted that the above-described characteristic information includes the optical characteristic information of the optical system, the resolution of the sensor unit, and the pixel size of the sensor unit. In addition, the installation information includes at least one of the height, angle, or direction in which the photoelectric conversion apparatus is installed. Furthermore, as one type of environmental information, the information of the movable apparatus includes at least one of vehicle speed information, acceleration information, steering angle information, brake information, engine information, and the like.

In addition, as environmental information, at least one of the information of the presence or absence, position, speed, acceleration, and distance, and the like of traffic participants (pedestrians, motorcycles, bicycles, and the like around the movable apparatus), information such as map information, GPS information, road conditions, road surface status, weather information, brightness of surroundings, time, and the like is included.

In addition, the control unit may set the first pixel region or the second pixel region based on the output of the ECU serving as a movement control unit. It should be noted that at least one of the position or size of the first pixel region and the second pixel region may be set by the user.

In the Present Embodiment, a case in which there is one attention region and one non-attention region will be explained. It should be noted that for explanation, the accumulation period of the first pixel region, which is the attention region, is set to be divided into four parts of a full frame period, and the accumulation period of the second pixel region, which is the non-attention region, is set to be one full frame period without division.

Here, the first pixel region starts from the pixel of row j1 and column k1 and extends to the pixel of row N1 and column M1, and image capturing is executed in four different accumulation periods, whereas the second pixel region starts from the pixel of row j2 and column k2 and extends to the pixel of row N2 and column M2, and image capturing is executed in a single accumulation period.

Next, in step S1602, the CPU of the control unit determines whether or not the region is the attention region. In a case in which the determination is “Yes,” the processing proceeds to step S1611 to perform processing to determine the accumulation period. In contrast, in a case in which the determination in step S1602 is “No,” the processing proceeds to step S1701.

Because the attention region is divided into four parts, i starts from 1 and repeats until 4. Therefore, in step S1611, the CPU of the control unit first sets the value of i to 1. Next, in step S1612, the CPU of the control unit outputs the count value Count of the counter 211 at time Ti to the memory 212. At this time, output is performed simultaneously for all memories. This operation corresponds to the operation at time T₁ in FIG. 7.

Next, in step S1613, the CPU of the control unit sets j=j1. j1 is the start position of the N row of the attention region. Next, in step S1614, the CPU of the control unit sets k=k1. k1 is the start position of the M column of the attention region.

In step S1615, the CPU of the control unit outputs the count value Count (j-k-i) in the memories j-k of FIG. 9 to the buffers. At this time, output is performed simultaneously to the buffers of columns 1 to M. This operation corresponds to the operation of loading the count value of the first row in FIG. 9 into the buffers.

In step S1616, the CPU of the control unit outputs the count value Count (j-k-i) of buffer k to the output circuit 114. This operation corresponds to the operation of reading out the signal of the buffer of the leftmost column of FIG. 9 from the output circuit.

Next, the processing proceeds to step S1617 of FIG. 17 via E, and in step S1617, the CPU of the control unit determines whether k<M1, and if “Yes,”, the CPU of the control unit increments k by 1 (k=k+1) in step S1618, then the processing returns to step S1616 via F. M1 is the end position of the M column in the attention region. This operation corresponds to the operation of reading out the signal of the buffer of the second column from the left in FIG. 9 from the output circuit.

In a case in which “No” has been determined in step S1617, that is, in a case in which k=M1, this means that the reading out of the signal of the buffer of the M1-th column of FIG. 9 from the output circuit has completed. Next, the processing proceeds to step S1619, and the CPU of the control unit determines whether j<N1.

N1 is the end position of the N row in the attention region. In a case in which “Yes” has been determined in step S1619, the CPU of the control unit sets j=j+1, and increments j by 1 in step S1620, then the processing returns to step S1614 via G. This operation corresponds to the operation for starting the reading out of the next row.

In a case in which “No” has been determined in step S1619, because this means that the reading out of all rows has completed, the processing proceeds to step S1621, and the CPU of the control unit determines whether or not i<4. In a case in which “Yes” has been determined in step S1621, the CPU of the control unit sets i=i+1, and increments i by 1, then the processing returns to step S1612 via H. This operation corresponds to the operation to start the reading out at the next time T₂.

In a case in which “No” has been determined in step S1621, because this means that the reading out at time T₄ has completed, the processing proceeds to step S1623, and the CPU of the control unit resets the counter 211 by a reset signal. This operation corresponds to the operation to reset the counter 211 at time T₄ in FIG. 7. After step S1623, the processing returns to step S1601 via M. In this manner, the signals accumulated in the sensor unit can be sequentially read out.

In contrast, because the non-attention region does not divide the full frame period, only the flow for i=4 is executed. Therefore, in step S1701, the CPU of the control unit sets i=4. Next, in step S1702, the CPU of the control unit outputs the count value Count of the counter 211 at time Ti to the memory 212. At this time, output is performed simultaneously for all memories. This operation corresponds to the operation at time T₁ in FIG. 7.

Next, in step S1703, the CPU of the control unit sets j=j2. j2 is the start position of the N row of the non-attention region. Next, in step S1704, the CPU of the control unit sets k=k2. k2 is the start position of the M column of the non-attention region.

In step S1705, the CPU of the control unit outputs the count value Count (j-k-i) in the memories j-k of FIG. 9 to the buffers. At this time, output is performed simultaneously to the buffers of columns 1 to M. This operation corresponds to the operation of loading the count value of the first row in FIG. 9 into the buffers.

In step S1706, the CPU of the control unit outputs the count value Count (j-k-i) of buffer k to the output circuit 114. This operation corresponds to the operation of reading out the signal of the buffer of the leftmost column in FIG. 9 from the output circuit.

Next, the processing proceeds to step S1707 of FIG. 17 via I, and in step S1707, the CPU of the control unit determines whether k<M2. If “Yes” in step S1707, the CPU of the control unit increments k by 1 (k=k+1) in step S1708, then the processing returns to step S1706 via J. M2 is the end position of the M column of the non-attention region. This operation corresponds to the operation of reading out the signal of the buffer of the second column from the left of FIG. 9 from the output circuit.

In a case in which the determination at step S1707 is “No,” that is, in a case in which k=M2, this means that the reading out of the signal of the buffer of the M2-th column in FIG. 9 from the output circuit has completed, and next, the processing proceeds to step S1709, and the CPU of the control unit determines whether j<N2.

N2 is the end position of the N row of the non-attention region. In a case in which “Yes” has been determined in step S1709, the CPU of the control unit sets j=j+1, and increments j by 1 in step S1710, then the processing returns to step S1704 via K. This operation corresponds to the operation for starting the reading out of the next row.

In a case in which “No” has been determined in step S1709, because this means that the reading out of all rows has completed, the processing proceeds to step S1711, and the CPU of the control unit determines whether j<4. In a case in which “Yes” has been determined in step S1711, the CPU of the control unit sets i=i+1, and increments i by 1, then the processing returns to step S1702 via L.

This operation corresponds to the operation to start the reading out at the next time T₂. However, because i is set to 4 in step S1701, the determination in step S1711 becomes “No.”

In a case in which “No” has been determined at step S1711, because this means that the reading out at time T₄ has completed, the processing proceeds to step S1713, and the CPU of the control unit resets the counter 211 by a reset signal. This operation corresponds to the operation to reset the counter 211 at time T₄ in FIG. 7. After step S1713, the processing returns to step S1601 via M. In this manner, the signals accumulated in the sensor unit can be sequentially read out.

Therefore, the attention region starts from the pixel of row j1 and column k1 and repeats up to the pixel of row N1 and column M1, with image capturing executed in four different accumulation periods, whereas the non-attention region starts from the pixel of row j2 and column k2 and repeats up to the pixel of row N2 and column M2, with image capturing executed only in a single accumulation period.

Next, the processing of images acquired in each of the attention region and the non-attention region by the photoelectric conversion apparatus 600 will be explained. The method for acquiring images from the attention region is based on the approach shown in FIG. 16 and FIG. 17. The photoelectric conversion apparatus 600 acquires images from the attention region over the four accumulation periods of Frame 1_1, Frame 1_2, Frame 1_3, and Frame 1_4 of FIG. 7. In contrast, the photoelectric conversion apparatus 600 acquires images of the non-attention region only during the accumulation period of Frame 1_4 of FIG. 7.

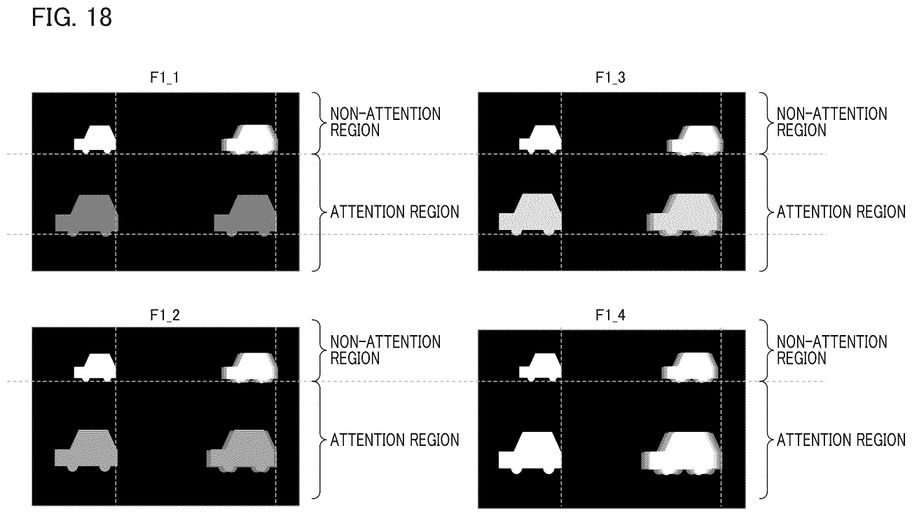

An example of images created according to the flow of FIG. 16 and FIG. 17 is shown in FIG. 18. FIG. 18 is a diagram showing an example of images for each of a plurality of accumulation periods, in which an attention region is set. In each of these figures, the range image capturing the near distance, which is the lower side, is set as the attention region, and the range image capturing the far distance, which is the upper side, is set as the non-attention region, and in addition, the vehicles on the left side are stationary, and the vehicles on the right side are moving from the right to the left at a certain speed.

As in FIG. 18, the region of the screen lower side, which is the attention region, is updated in four stages from Frame 1_1 to Frame 1_4, each stage being updated respectively. Therefore, the stationary vehicle gradually appears as an image with higher luminance as the accumulation period becomes longer from Frame 1_1 to Frame 1_4. In addition, as the accumulation period becomes longer from Frame 1_1 to Frame 1_4, the moving vehicle generates blur in the forward and backward travel direction, and the luminance of the overlapping parts increases.

In contrast, the region of the screen upper side, which is the non-attention region, is updated only by the output of Frame 1_4. Therefore, the stationary vehicle, updated with each full-frame period and captured during the accumulation period of the full frame, becomes an image with high luminance. Similarly, the moving vehicle, updated with each full-frame period and captured during the accumulation period of the full frame, generates blur in the forward and backward travel direction, and the luminance of the overlapping parts becomes higher.

Therefore, in the non-attention region, the images from Frame 1_1 to Frame 1_3 are all images captured during the accumulation period of Frame 1_4 in the preceding full frame period. In addition, in Frame 1_4, the image is updated to the image captured during the accumulation period of Frame 1_4 in the current full frame period.

In this manner, by following the flowcharts of FIG. 16 and FIG. 17, the attention region is updated four times within the full frame period, making it possible to acquire images in a shorter time than the full frame period and to perform faster recognition. In contrast, because the non-attention region is updated only once within the full frame period, it becomes possible to reduce the data volume and lower the power consumption.

Based on the image data created according to the flowcharts of FIG. 16 and FIG. 17, subsequent processing is performed according to the characteristics and applications of the photoelectric conversion apparatus 600.

For example, in the case of a surveillance camera, the control unit 605 performs behavior monitoring, image capturing, and recording of the target person. In addition, in some cases, it becomes possible to perform, via the communication unit 607, the displaying of warnings, illuminating of lights provided in the surveillance camera, generating of warning sounds, and the like.

In addition, in the case of an in-vehicle camera or the like, the control unit 605 performs issuing of alerts and displaying of warnings via the ECU, and activation of safety devices by the vehicle control unit 702 for decelerating or stopping the vehicle, thereby making it possible to reduce or avoid collisions.

In addition, for example, as a camera, by performing person recognition or recognizing a registered face, it becomes possible to acquire images in an appropriate accumulation time when in the image capturing region. In addition, as a pet camera, it becomes possible to recognize the pet, to remotely confirm the condition of the pet, or to capture images of the pet.

In addition, in the case of use as a surveillance camera, it is possible to set specific places or regions as attention regions to perform situational awareness, monitoring, prevention of improper actions, and collecting evidence serving as a record in locations requiring safety management or surveillance (for example, parking lots, public facilities, factories, and the like). Thereby, it becomes possible to monitor attention regions at a higher frequency and to record and display video and audio.

In addition, in a case of use as a defect detection camera in a factory, use is possible to support quality management and efficiency of the manufacturing process, and to perform early detection and elimination of defective products, troubleshooting of the production line, quality improvement, and the like. In this case, it becomes possible to more accurately detect and record product defects and abnormalities in the manufacturing lines and work sites of the factory.

In addition, in a case of use as a packaging inspection camera in a factory, it becomes possible to strengthen quality management of products and to perform inspection of packaging conditions, label accuracy, and defects to ensure the integrity of the packaging and the accuracy of labels.

In a case of use as a sorting camera for logistics, it is possible to improve the efficiency and accuracy of logistics operations in logistics warehouses, distribution centers, and the like, and to achieve appropriate product management and rapid distribution processes. In addition, it becomes possible to recognize shapes, sizes, barcodes, and the like of products and packages, and to perform accurate sorting and distribution processing.

In a case of use as a camera for an endoscope, it becomes possible to more accurately observe the internal state in endoscopic surgery or diagnosis, and to support the diagnosis of diseases and formulation of treatment plans by acquiring high-quality video of the interior of the body and organs with a camera incorporated into the endoscope used in the medical field.

In a case of use as a camera for detecting care-required states, it becomes possible to monitor the living conditions of the elderly or persons requiring care for the purpose of safety and life support, and to detect abnormalities or dangerous situations, and to perform early detection and support for falls, abnormal behavior, and emergencies.

In a case of use as a camera for infrastructure monitoring, it becomes possible to monitor infrastructure such as roads, bridges, railroads, and power plants, to maintain safety and reliability, and to perform early warning and appropriate maintenance management by detecting abnormalities, damage, or improper activities.

In addition, in a case of use as a camera for infrastructure monitoring, it becomes possible to monitor public places and facilities and specific areas for ensuring public safety, deterring crime, preventing improper conduct, collecting evidence for incident investigations, and the like, and to perform prevention, monitoring, and recording of improper conduct or criminal conduct.

In addition, in a case of use as a camera for agriculture, it becomes possible to support appropriate cultivation management, early detection of diseases and pests, and the implementation of effective agricultural measures to improve the productivity and quality of crops. In this case, it becomes possible to monitor the growth conditions of crops and the occurrence of diseases and pests and to provide video data useful for agricultural production management.

### Seventh Embodiment

Next, a Seventh Embodiment will be explained. In the Seventh Embodiment, a method of setting the accumulation period of the attention region according to the brightness and the like of the attention region will be explained.

It has been explained that in a monitoring camera or an in-vehicle camera attached to a movable apparatus, it is effective to acquire images of subjects in close proximity or subjects on the sides of the movable apparatus with a short accumulation period at an early timing. However, in contrast, it is known that if the accumulation period is short, the ratio of noise in the signal component increases, and so-called S/N deteriorates.

This becomes particularly pronounced in cases in which dark regions are image captured. Therefore, if the accumulation period is shortened to acquire images in the case in which the attention region is dark, the resulting image will have poor S/N, making it difficult for appropriate display and for use in subsequent processing.

Accordingly, the issue arises that performing originally unnecessary processing makes it impossible to execute proper determination and leads to increased power consumption in the apparatus. Therefore, in the Seventh Embodiment, a method for capturing images having good S/N by adjusting the accumulation period according to the brightness of the attention region will be explained.

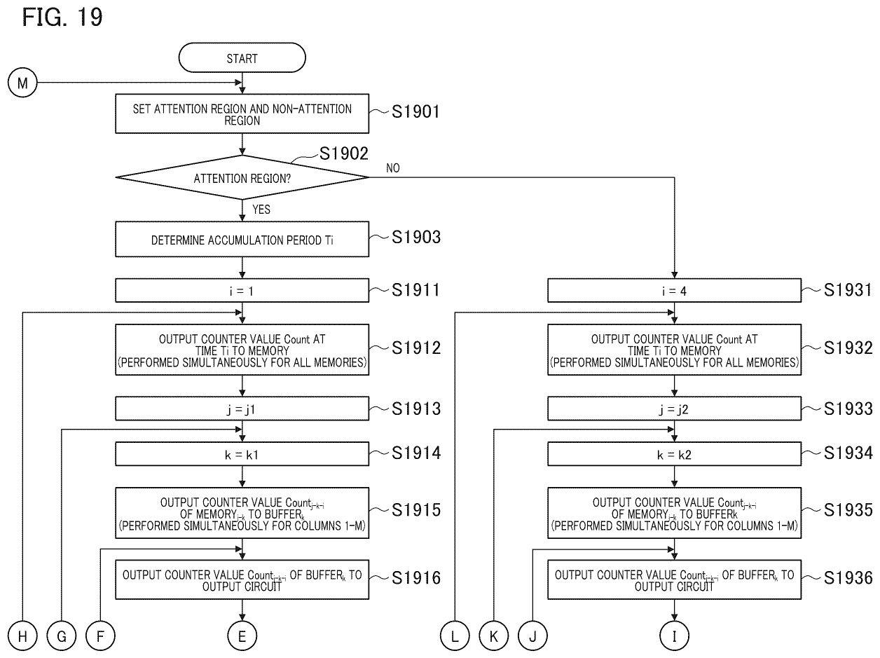

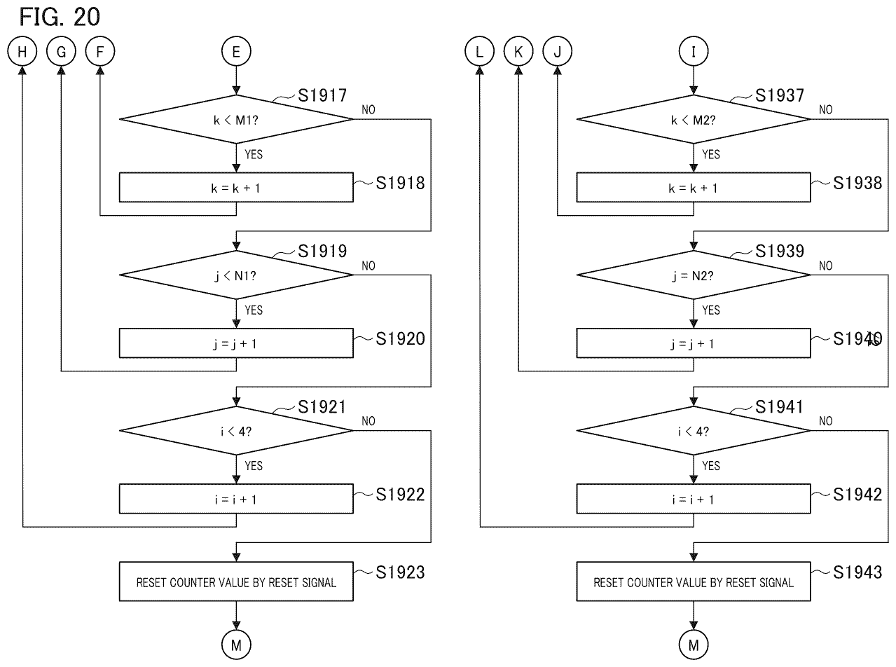

FIG. 19 is a flowchart showing details of an example of driving the sensor unit 100 by setting the accumulation period in the Seventh Embodiment, and FIG. 20 is a continuation of the flowchart of FIG. 19. It should be noted that by executing a computer program stored in the memory, the CPU serving as a computer within the control unit 605 sequentially performs the operations of each step in the flowcharts of FIG. 19 and FIG. 20.

First, in step S1901, the CPU of the control unit sets the attention region. Similar to the previous embodiments, the attention region is set based on at least one piece of information among product information, installation information, and environmental information of the photoelectric conversion apparatus 600 recorded in the control unit 605 of the photoelectric conversion apparatus 600.

Next, in step S1902, the CPU of the control unit determines whether the region is an attention region or a non-attention region. In the attention region, the process proceeds to the step S1911 of FIG. 19, and the CPU of the control unit performs the processing to determine the accumulation period. In contrast, in the non-attention region, the process proceeds to step S1931.

Next, in step S1903, the CPU of the control unit determines the accumulation period of the attention region. In the Present Embodiment, the control unit 605 calculates, for example, the average luminance value of the image acquired in the previous full-frame period within the attention region, and records the LUT (Look-Up Table) or formula corresponding to the luminance value in the memory of the control unit 605, and uses this LUT or formula to determine the accumulation period.

In this manner, in the Present Embodiment, the length of at least one of the first accumulation period and the second accumulation period is set based on the luminance information of the signals generated in at least one of the first accumulation period and the second accumulation period.

It should be noted that the luminance value may be determined not only from the average luminance but also based on the peak or skewness, spread or variance of the histogram, and the like. In addition, the luminance difference with adjacent pixels in the screen may be calculated, and the noise amount may be calculated from the histogram of the difference, and the accumulation period may be determined from the result. Moreover, the luminance value may also be calculated not only from the previous full-frame period, but also from the average value of the previous plurality of full frames, or from the average luminance, histogram, and the like of each accumulation period within the full-frame period.

In the Present Embodiment, although the flowcharts of FIG. 19 and FIG. 20 show the case of four accumulation periods, the accumulation periods are not limited to four and may be one, three, or more than four. Then, in step S1903, the CPU of the control unit sets the determined accumulation period (Ti).

In step S1911 of FIG. 19, the CPU of the control unit sets i=1. Next, in step S1912, the CPU of the control unit outputs the count value Count of the counter 211 at time Ti to the memory 212. At this time, output is performed simultaneously for all memories. This operation corresponds to the operation at time T₁ in FIG. 7.

Next, in step S1913, the CPU of the control unit sets j=j1. j1 is the start position of the N row of the attention region. Next, in step S1914, the CPU of the control unit sets k=k1. k1 is the start position of the M column of the attention region.

In step S1915, the CPU of the control unit outputs the count value Count (j-k-i) in the memories j-k of FIG. 9 to the buffers. At this time, output is performed simultaneously to the buffers of columns 1 to M. This operation corresponds to the operation of loading the count value of the first row in FIG. 9 into the buffers.

In step S1916, the CPU of the control unit outputs the count value Count (j-k-i) of buffer k to the output circuit 114. This operation corresponds to the operation of reading out the signal of the buffer of the leftmost column of FIG. 9 from the output circuit.

Next, the processing proceeds to step S1917 of FIG. 20 via E, and in step S1917, the CPU of the control unit determines whether k<M1. If “Yes” in step S1917, the CPU of the control unit increments k by 1 (k=k+1) in step S1918, then the processing returns to step S1916 via F. M1 is the end position of the M column in the attention region. This operation corresponds to the operation of reading out the signal of the buffer of the second column from the left in FIG. 9 from the output circuit.

In a case in which the determination at step S1917 is “No,” that is, in a case in which k=M1, this means that the reading out of the signal of the buffer of the M-th column in FIG. 9 from the output circuit has completed, and next, the processing proceeds to step S1919, and the CPU of the control unit determines whether j<N1.

N1 is the end position of the N row in the attention region. In a case in which “Yes” has been determined in step S1919, the CPU of the control unit sets j=j+1, and increments j by 1 in step S1920, then the processing returns to step S1914 via G. This operation corresponds to the operation for starting the reading out of the next row.

In a case in which “No” has been determined at step S1919, this means that the reading out of all rows has completed, so the process proceeds to step S1921, and the CPU of the control unit determines whether i<4. In a case in which “Yes” has been determined in step S1921, the CPU of the control unit sets i=i+1, increments i by 1, then returns to step S1912 via H. This operation corresponds to the operation to start the reading out at the next time T₂.

In a case in which “No” has been determined at step S1921, because this means that the reading out at time T₄ has completed, the processing proceeds to step S1923, and the CPU of the control unit resets the counter 211 by a reset signal.

This operation corresponds to the operation to reset the counter 211 at time T₄ in FIG. 7. After step S1713, the processing returns to step S1901 via M. In this manner, the signals accumulated in the sensor unit can be sequentially read out.

In contrast, because the accumulation period of the non-attention region is equivalent to the full frame period, images are acquired during the defined accumulation period. That is, in step S1931 of FIG. 19, the CPU of the control unit sets i=4.

Next, in step S1932, the CPU of the control unit outputs the count value Count of the counter 211 at time T₁ to the memory 212. At this time, output is performed simultaneously for all memories. This operation corresponds to the operation at time T₁ in FIG. 7.

Next, in step S1933, the CPU of the control unit sets j=j2. j2 is the start position of the N row of the non-attention region. Next, in step S1934, the CPU of the control unit sets k=k2. k2 is the start position of the M column of the non-attention region.

In step S1935, the CPU of the control unit outputs the count value Count (j-k-i) in the memories j-k of FIG. 9 to the buffers. At this time, output is performed simultaneously to the buffers of columns 1 to M. This operation corresponds to the operation of loading the count value of the first row in FIG. 9 into the buffers.

In step S1936, the CPU of the control unit outputs the count value Count (j-k-i) of buffer k to the output circuit 114. This operation corresponds to the operation of reading out the signal of the buffer of the leftmost column of FIG. 9 from the output circuit.

Next, the processing proceeds to step S1937 of FIG. 20 via I, and in step S1937, the CPU of the control unit determines whether k<M2. If “Yes” in step S1937, the CPU of the control unit increments k by 1 (k=k+1) in step S1938, then the processing returns to step S1936 via J. M2 is the end position of the M column in the non-attention region. This operation corresponds to the operation of reading out the signal of the buffer of the second column from the left in FIG. 9 from the output circuit.

In a case in which the determination at step S1937 is “No,” that is, in a case in which k=M2, this means that the reading out of the signal of the buffer of the M2-th column in FIG. 9 from the output circuit has completed, and next, the processing proceeds to step S1939, and the CPU of the control unit determines whether j<N2.

N2 is the end position of the N row in the attention region. In a case in which “Yes” has been determined in step S1939, the CPU of the control unit sets j=j+1, and increments j by 1 in step S1940, then the processing returns to step S1944 via K. This operation corresponds to the operation for starting the reading out of the next row.

In a case in which “No” has been determined in step S1939, because this means that the reading out of all rows has completed, the processing proceeds to step S1941, and the CPU of the control unit determines whether i<4. In a case in which “Yes” has been determined in step S1941, the CPU of the control unit sets i=i+1, and increments i by 1, then the processing returns to step S1932 via L. This operation corresponds to the operation to start the reading out at the next time T₂. Because i is set to 4 in step S1612, the determination in step S1621 becomes “No.”

In a case in which “No” has been determined at step S1941, because this means that the reading out at time T₄ has completed, the processing proceeds to step S1943, and the CPU of the control unit resets the counter 211 by a reset signal. This operation corresponds to the operation to reset the counter 211 at time T₄ in FIG. 7. After step S1943, the processing returns to step S1901 via M.

In this manner, the signals accumulated in the sensor unit can be sequentially read out. It should be noted that images in the non-attention region may also be acquired similarly in the accumulation period determined by the control unit 605. In this case, a flow for setting the accumulation period before acquiring the images is added.

For example, in the above-described embodiment, although accumulation is performed with an accumulation period as short as ¼ of the full frame period, according to the recognition accuracy in the recognition unit 604, the length of the shortest accumulation period may be changed to, for example, ⅕ full frame period or ⅓ full frame period and the like. Alternatively, the length of the shortest accumulation period may be changed according to the brightness of the subject. In addition, the recognition unit may be further configured to recognize the subject based on the signals that are generated in the second accumulation period.

Furthermore, even in a case in which the readout cycle is set to every ¼ full frame period, the counter may be reset during the accumulation period of frame 1_1 of FIG. 7 according to the brightness of the subject, image recognition accuracy, and the like. Thereby, the actual accumulation period may be shortened to less than ¼ of the full frame period.

Alternatively, the counter may temporarily be reset at time T₁ of FIG. 7 and the like. As a result, the count value that is read out at time T₄ may be adjusted. It should be noted that in the above embodiments, although the accumulation period was set to equal intervals, the accumulation period is not limited thereto.

In addition, in the above embodiments, examples in which various processing is performed based on the captured image data by various cameras, devices attached to the cameras, and personal computers have been explained.

For example, in the case of a surveillance camera, the control unit 605 performs monitoring, image capturing, and recording of the behavior of the target person. Then, in some cases, the control unit 605, via the communication unit 607, performs warning displays, illumination of a light attached to the surveillance camera, generation of a warning sound, and the like. In addition, in the case of an in-vehicle camera and the like, the control unit 605, via the ECU 701, performs alert issuance, warning displays, and operation of a safety device via the vehicle control unit 702 to decelerate or stop the vehicle, and the like.

### Eighth Embodiment

In the Eighth Embodiment, before performing various processing, the control unit 605 determines whether the images acquired by the photoelectric conversion apparatus 600 are suitable for performing subsequent processing.

Thereby, the load related to processing is further reduced, enabling the reduction of processing load, power consumption, and the like. Furthermore, it is possible to avoid making incorrect determinations due to unsuitable images, causing false warnings in surveillance cameras, or incorrect activation of safety devices in in-vehicle cameras, and the like.

In the Eighth Embodiment, the image captured image data is evaluated by the control unit 605. Then, by using the average luminance value and the like of the output of each full frame, whether the image is suitable or not is determined, and in the case in which the image is suitable, whether to proceed to the next processing is determined.

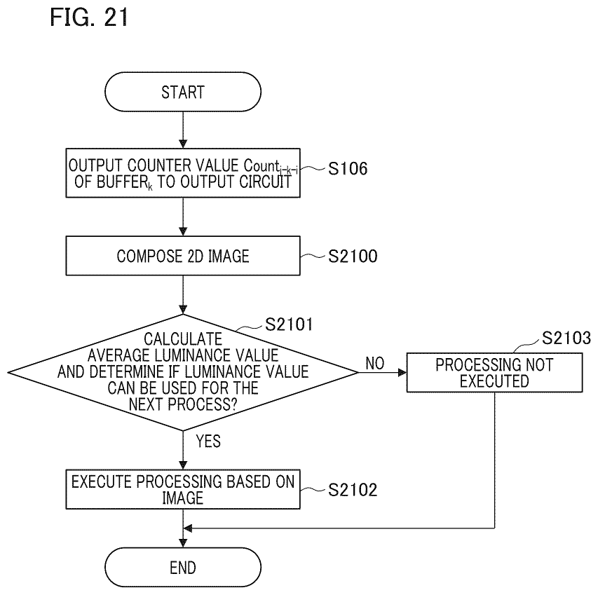

FIG. 21 is a flowchart showing an example of an operation in the control unit after composing an image according to an Eighth Embodiment. It should be noted that by executing a computer program stored in the memory, the CPU serving as a computer within the control unit 605 sequentially performs the operations of each step in the flowchart of FIG. 21.

The flow until acquiring the image uses, for example, the examples shown in FIG. 16 and FIG. 17. First, in step S2100, the CPU of the control unit composes the image by using the count value output in step S106 of FIG. 16.

Then, in step S2101, the CPU of the control unit determines whether the image is suitable for use in the next processing. Here, an unsuitable image refers to an image that is too noisy due to a poor signal-to-noise ratio (S/N) or is too dark to recognize.

As a determination method in step S2101, it is possible to obtain a determination based on the average luminance data of the acquired image. That is, the average luminance value is calculated by the control unit 605, and based on that value, it is determined as to whether the image can be used for the next processing. That is, the control unit controls whether or not to perform the predetermined processing in the control unit according to the luminance information of the signal generated in at least one of the first accumulation period and the second accumulation period.

In addition, the luminance value may be obtained not only from the average luminance but also from the peak, the skewness of the peak, the spread, the variance of the histogram, and the like. Furthermore, the luminance difference with adjacent pixels in the screen may be obtained, the noise amount may be calculated from the histogram of the difference, and based on the result, a determination may be made on whether the image can be used for the next processing.

Moreover, the determination may also be made not only from the previous full frame but also from the average value of the previous plurality of full frames and the like, or from the average luminance, histogram, and the like of each accumulation period within the full-frame period. In a case in which the image is determined to be suitable in step S2101, then in step S2102, the CPU of the control unit performs the processing by using a computer program or the like of the control unit 605.

In contrast, in a case in which the image is determined to be unsuitable, in step S2103, the CPU of the control unit does not perform processing on the image by using the computer program of the control unit 605 and stops the processing of the computer program until the image of the next accumulation period is acquired.

By performing the flow as shown in FIG. 21, it is possible to reduce the number of unnecessary processing operations performed by the control unit 605, and it becomes possible to reduce power consumption. Furthermore, it is possible to avoid making incorrect determinations due to unsuitable images, or causing false warnings in surveillance cameras, or incorrect activation of safety devices in in-vehicle cameras, and the like.

It should be noted that in the above-explained embodiments, although the movable apparatus 700 has been explained, for example, by using the example of an automobile, the movable apparatus may be any movable object such as an aircraft, train, ship, drone, AGV, robot, and the like.

In addition, the photoelectric conversion apparatus 600 of the above-described embodiment is not limited to moving bodies and may also be mounted on walls, columns, and the like. In such cases, as installation information when the photoelectric conversion apparatus 600 is mounted on walls, columns, and the like, it is desirable to retain installation height, installation angle, and the like in the memory unit 606 and the like.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the photoelectric conversion apparatus and the like through a network or various storage media. Then, a computer (or a CPU, an MPU, or the like) of the photoelectric conversion apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-139501, filed on Aug. 30, 2023, which is hereby incorporated by reference herein in its entirety.

What is claimed is:

1. A photoelectric conversion apparatus comprising:
an optical system;
a plurality of pixels, each provided with:
a photoelectric conversion unit configured to generate pulses in response to photons;
a counter configured to count the number of the pulses; and
a memory configured to store a count value of the counter;
one or more memories storing instructions; and
one or more processors executing the instructions to:
generate a signal based on the difference between the count value of the counter at the start time and end time of an accumulation period in the photoelectric conversion unit;
control a signal generated during a first accumulation period so that the signal is output during the period from the end of the first accumulation period to the end of a second accumulation period, wherein the first accumulation period is shorter than the second accumulation period, and wherein in one full-frame period, the first accumulation period and a second accumulation period longer than the first accumulation period are included; and
set, in a sensor unit including the plurality of pixels, a first pixel region having at least the first accumulation period and the second accumulation period, and a second pixel region having at least the second accumulation period.

2. The photoelectric conversion apparatus according to claim 1, wherein the one or more processors further execute the instructions to set the first pixel region and the second pixel region based on the image that was read out from the sensor unit.

3. The photoelectric conversion apparatus according to claim 1, wherein the first accumulation period and the second accumulation period overlap.

4. The photoelectric conversion apparatus according to claim 2, wherein the first accumulation period and the second accumulation period start simultaneously.

5. The photoelectric conversion apparatus according to claim 1, wherein the end of the second accumulation period coincides with the end of the full frame period.

6. The photoelectric conversion apparatus according to claim 1, wherein the one or more processors further executing the instructions to recognize a subject based on a signal generated in at least the first accumulation period.

7. The photoelectric conversion apparatus according to claim 6, wherein the one or more processors further executing the instructions to recognize the subject based on a signal generated in the second accumulation period.

8. The photoelectric conversion apparatus according to claim 1, further comprising a display unit configured to display the signal generated in the second accumulation period as an image.

9. The photoelectric conversion apparatus according to claim 1, wherein the sensor unit includes an avalanche photodiode.

10. The photoelectric conversion apparatus according to claim 2, wherein the one or more processors further executing the instructions to set the first pixel region or the second pixel region based on at least one of characteristic information related to characteristics of the photoelectric conversion apparatus, installation information related to an installation state of the photoelectric conversion apparatus, and environmental information related to a surrounding environment of the photoelectric conversion apparatus.

11. The photoelectric conversion apparatus according to claim 10, wherein the one or more processors further executing the instructions to set at least one of the position, size, or accumulation period of the first pixel region or the second pixel region based on at least one of the characteristic information, the installation information, and the environmental information.

12. The photoelectric conversion apparatus according to claim 10, wherein the characteristic information includes the optical characteristic information of the optical system, the resolution of the sensor unit, and the pixel size of the sensor unit.

13. The photoelectric conversion apparatus according to claim 10, wherein the installation information includes at least one of the height, angle, or direction in which the photoelectric conversion apparatus is installed.

14. The photoelectric conversion apparatus according to claim 1, wherein the one or more processors further executing the instructions to set the first pixel region or the second pixel region according to distance information of a subject.

15. The photoelectric conversion apparatus according to claim 1, wherein the one or more processors further executing the instructions to set the length of at least one of the first accumulation period and the second accumulation period based on luminance information of the signal generated in at least one of the first accumulation period and the second accumulation period.

16. The photoelectric conversion apparatus according to claim 1, wherein the one or more processors further executing the instructions to control whether or not to perform predetermined processing in the control unit according to the luminance information of the signal that is generated in at least one of the first accumulation period and the second accumulation period.

17. A movable apparatus comprising:
an optical system;
a plurality of pixels, each provided with:
a photoelectric conversion unit configured to generate pulses in response to photons;
a counter configured to count the number of the pulses; and
a memory configured to store a count value of the counter;
one or more memories storing instructions; and
one or more processors executing the instructions to:
generate a signal based on the difference between the count value of the counter at the start time and end time of an accumulation period in the photoelectric conversion unit;
control a signal generated during a first accumulation period so that the signal is output during the period from the end of the first accumulation period to the end of a second accumulation period, wherein in one full frame period, there are at least a first accumulation period and a second accumulation period, and the first accumulation period is shorter than the second accumulation period;
set, in a sensor unit including the plurality of pixels, a first pixel region having at least the first accumulation period and the second accumulation period, and a second pixel region having at least the second accumulation period;
control the operation of the movable apparatus; and
set the first pixel region or the second pixel region based on the control of the movement.

18. A control method for controlling a photoelectric conversion apparatus comprising an optical system and a plurality of pixels, each pixel provided with:
a photoelectric conversion unit configured to generate pulses in response to photons; a counter configured to count the number of the pulses; and
a memory configured to store a count value of the counter, the method comprising:
generating a signal based on the difference between the count value of the counter at the start time and end time of an accumulation period in the photoelectric conversion unit;
controlling a signal generated during a first accumulation period so that the signal is output during the period from the end of the first accumulation period to the end of a second accumulation period, wherein in one full frame period, there are at least a first accumulation period and a second accumulation period, and the first accumulation period is shorter than the second accumulation period; and
setting, in a sensor unit including pixels, a first pixel region having at least the first accumulation period and the second accumulation period, and a second pixel region having at least the second accumulation period.

19. A non-transitory computer-readable storage medium configured to store a computer program for a photoelectric conversion apparatus comprising:
an optical system; and
a plurality of pixels, each pixel provided with:
a photoelectric conversion unit configured to generate pulses in response to photons;
a counter configured to count the number of the pulses; and
a memory configured to store a count value of the counter, to execute the following processes:
generating a signal based on the difference between the count value of the counter at the start time and end time of an accumulation period in the photoelectric conversion unit;
controlling a signal generated during a first accumulation period so that the signal is output during the period from the end of the first accumulation period to the end of a second accumulation period, wherein in one full frame period, there are at least a first accumulation period and a second accumulation period, and the first accumulation period is shorter than the second accumulation period; and
setting, in a sensor unit including the plurality of pixels, a first pixel region having at least the first accumulation period and the second accumulation period, and a second pixel region having at least the second accumulation period.
